(19) United States
(12) Patent Application Publication
(10) Pub. No.: US 2024/0288938 A1
(43) Pub. Date: Aug. 29, 2024

(54) Wearable Electronic Device, Electronic Device System and Methods Thereof

(71) Applicant: Telefonaktiebolaget LM Ericsson (publ), Stockholm (SE)

(72) Inventors: Fredrik Dahlgren, Lund (SE); Alexander Hunt, Tygelsjö (SE); Héctor Caltenco, Oxie (SE)

(21) Appl. No.: 18/289,969

(22) PCT Filed: May 10, 2021
(86) PCT No.: PCT/EP2021/062358

§ 371 Date: Nov. 8, 2023

(51) Int. Cl. G06F 3/01; G06F 1/16; G06F 3/0346; G06F 3/044; G06F 3/04812; G06F 3/0482

(52) U.S. Cl. CPC G06F 3/014; G06F 1/163; G06F 3/017; G06F 3/0346; G06F 3/04812; G06F 3/0482; G06F 3/044

(57) ABSTRACT

A method, performed by a wearable electronic device, for controlling a user interface, Ul. The wearable electronic device is configured to communicate with an electronic ring-shaped device comprising one or more touch sensors. The method comprises controlling the Ul based on touch sensor data communicated from the electronic ring-shaped device and further based on motion sensor data from a motion sensor of the wearable electronic device.

### TECHNICAL FIELD

The embodiments herein relate to a wearable electronic device, an electronic device system and methods for controlling a user interface. A corresponding computer program and a computer program carrier are also disclosed.

### BACKGROUND

Today's smartwatches have a touchscreen and typically one or multiple buttons. Interaction with the watch is either done by using fingers from the other hand, voice control, or some gesture-based simplistic control such as showing display content when the hand holding the watch is raised towards the user.

A problem with the typical user interfaces (UIs) for smart watches is that they typically require both hands to be involved. Exceptions are very basic gestures, such as raising the arm to light up the touchscreen, and voice control. The latter being difficult to use in many circumstances and limited in usefulness for many applications.

There are many situations where the second arm or hand, i.e., not the arm of the watch, is busy and cannot be used. This may be when carrying a bag, controlling equipment, or because of other inabilities to use both arms such as injury and/or disability.

### SUMMARY

Other electronic devices, such as TVs and computers may be remotely controlled by electronic ring-shaped devices with built-in sensors such as inertial measurement units, (IMU). For example, some ring devices are used to make gesture input to other devices such as computers or smartphones. The controlled device may then in turn have a large display and a content being shown on the display, e.g., presentations or games, may be controlled by gestures from the finger or hand carrying the ring.

The ring devices typically use wireless connectivity such as Bluetooth to communicate with the remote device they control.

The ring devices based on IMU's being capable of detecting certain gestures typically work better when the complete hand can be moved, which is the case when you control an external screen or device but not the case when controlling a watch being carried by the same arm that should be as still as possible when looking at it. This severely limits the usability of such ring devices to control smart watches.

Furthermore, there is a substantially higher risk for false positives when a gesture should be detected by an IMU or accelerometer in the ring device if only the relative movement of the finger vs. the arm is significant, and the arm must be relatively still but is still subject to some movements due to the user's action e.g., walking, running, sailing, etc.

Another proposed way of controlling a remote device with a ring device is by integrating a touchpad with the ring device. These ring devices are proposed to be used as an input device to the remote device. A problem with existing electronic ring-shaped devices that have in-built touchpads is that they are very clumsy to wear, in that they have a big surface that acts like a touch pad of a laptop but in a smaller shape. The ring becomes difficult to make good-looking and might be awkward to use.

An object of embodiments herein may be to obviate some of the problems related to controlling electronic devices, such as wearable electronic device, or at least reduce the impact of them.

According to an aspect, the object is achieved by method, performed by a wearable electronic device, for controlling a user interface, UI. The wearable electronic device is configured to communicate with an electronic ring-shaped device comprising one or more touch sensors. The method comprises controlling the UI based on touch sensor data communicated from the electronic ring-shaped device and further based on motion sensor data from a motion sensor of the wearable electronic device.

According to a further aspect, the object is achieved by a wearable electronic device configured to control a user interface, UI. The wearable electronic device comprises a motion sensor and is further configured to:
communicate with an electronic ring-shaped device comprising one or more touch sensors; and
control the UI based on touch sensor data communicated from the electronic ring-shaped device and further based on motion sensor data from the motion sensor.

According to a further aspect, the object is achieved by a method performed by an electronic device system comprising a wearable electronic device and an electronic ring-shaped device. The wearable electronic device comprises a motion sensor. The electronic ring-shaped device comprises one or more touch sensors. The method comprises:
communicating, by the electronic ring-shaped device, touch sensor data from the one or more touch sensors to the wearable electronic device; and
controlling, by the wearable electronic device, a UI based on the touch sensor data and further based on motion sensor data from the motion sensor.

According to a further aspect, the object is achieved by an electronic device system comprising a wearable electronic device and an electronic ring-shaped device. The wearable electronic device comprises a motion sensor. The electronic ring-shaped device comprises one or more touch sensors. The electronic device system is configured to:
communicate, by the electronic ring-shaped device, touch sensor data from the one or more touch sensors to the wearable electronic device; and
control a UI, by the wearable electronic device, based on the touch sensor data and further based on motion sensor data from the motion sensor.

The UI may be a UI of the wearable electronic device itself, or a user interface of a further electronic device other than the wearable electronic device and the electronic ring-shaped device. In some embodiments the UI is a graphical UI (GUI).

According to a further aspect, the object is achieved by a computer program comprising instructions, which when executed by a processor, causes the processor to perform actions according to any of the aspects above.

According to a further aspect, the object is achieved by a carrier comprising the computer program of the aspect above, wherein the carrier is one of an electronic signal, an optical signal, an electromagnetic signal, a magnetic signal, an electric signal, a radio signal, a microwave signal, or a computer-readable storage medium.

Since the electronic wearable electronic device controls the UI based on a touch sensor data communicated from the electronic ring-shaped device and further based on motion sensor data from the motion sensor of the wearable electronic device the navigation of the GUI is made easier since it is possible to more easily control the GUI through a one-handed operation, for example with the arm and hand that the wearable electronic device is arranged on.

For example, swiping through lists or navigating a menu is less limited compared to using only a prior art touch sensor, such as a touch pad, in the electronic ring-shaped device to control the UI, due to their limited size in combination with the limited movement of the finger that touches the electronic ring-shaped device.

A further advantage of embodiments herein is that they reduce the risk for false positives when a gesture is detected by the touch sensor of the electronic ring-shaped device.

A further advantage of embodiments herein is that the size of the electronic ring-shaped device is reduced since the motion sensor resides in the wearable electronic device. This also reduces the power consumption of the electronic ring-shaped device.

### BRIEF DESCRIPTION OF THE DRAWINGS

In the figures, features that appear in some embodiments are indicated by dashed lines.

The various aspects of embodiments disclosed herein, including particular features and advantages thereof, will be readily understood from the following detailed description and the accompanying drawings, in which:

FIG. 1a illustrates exemplifying embodiments of wearable electronic devices,

FIG. 1b illustrates exemplifying embodiments of electronic devices,

FIG. 1c illustrates exemplifying embodiments of further electronic devices,

FIG. 2a illustrates exemplifying embodiments of a wearable electronic ring-shaped device,

FIG. 2b illustrates further exemplifying embodiments of a wearable electronic ring-shaped device,

FIG. 2c illustrates further exemplifying embodiments of a wearable electronic ring-shaped device,

FIG. 2d illustrates details of exemplifying embodiments of a wearable electronic ring-shaped device,

FIG. 2e illustrates details of further exemplifying embodiments of a wearable electronic ring-shaped device,

FIG. 2f illustrates further exemplifying embodiments of a wearable electronic ring-shaped device,

FIG. 2g is a block diagram illustrating embodiments of the wearable electronic ring-shaped device and a further wearable electronic device,

FIG. 2h illustrates further exemplifying embodiments of a wearable electronic ring-shaped device,

FIG. 3a is a flowchart illustrating embodiments of a method performed by a wearable electronic device,

FIG. 3b is a flowchart illustrating embodiments of a method performed by a wearable electronic ring-shaped device,

FIG. 4a is a flowchart illustrating further embodiments of a method performed by a wearable electronic ring-shaped device,

FIG. 4b illustrates further embodiments of a method performed by a wearable electronic ring-shaped device,

FIG. 4c illustrates further embodiments of a method performed by a wearable electronic ring-shaped device,

FIG. 4d is a flowchart illustrating yet further embodiments of a method performed by a wearable electronic ring-shaped device,

FIG. 4e is a flowchart illustrating embodiments of a method performed by a wearable electronic ring-shaped device and a further wearable electronic device,

FIG. 5 is a block diagram illustrating embodiments of a wearable electronic device.

FIG. 6 is a block diagram illustrating embodiments of an electronic ring-shaped device.

### DETAILED DESCRIPTION

As mentioned above, an object of embodiments herein is to provide a robust solution for one-handed operation of a wearable electronic device such as a smart watch, when controlling a user interface. The user interface may be part of and/or used to control the wearable electronic device, such as a GUI of the wearable electronic device. However, the user interface may also be part of and/or used to control a further electronic device.

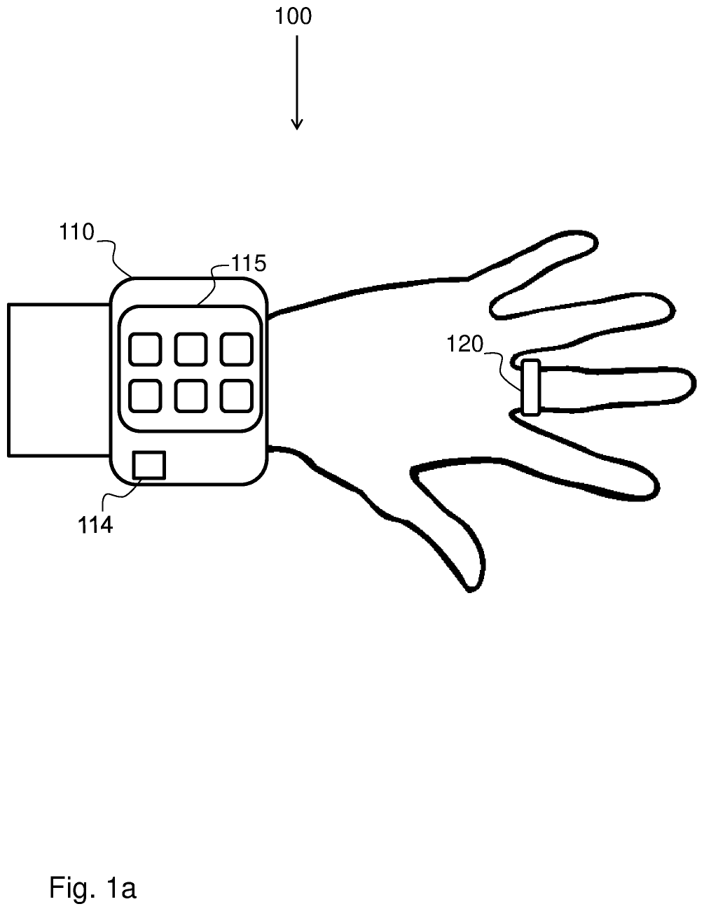

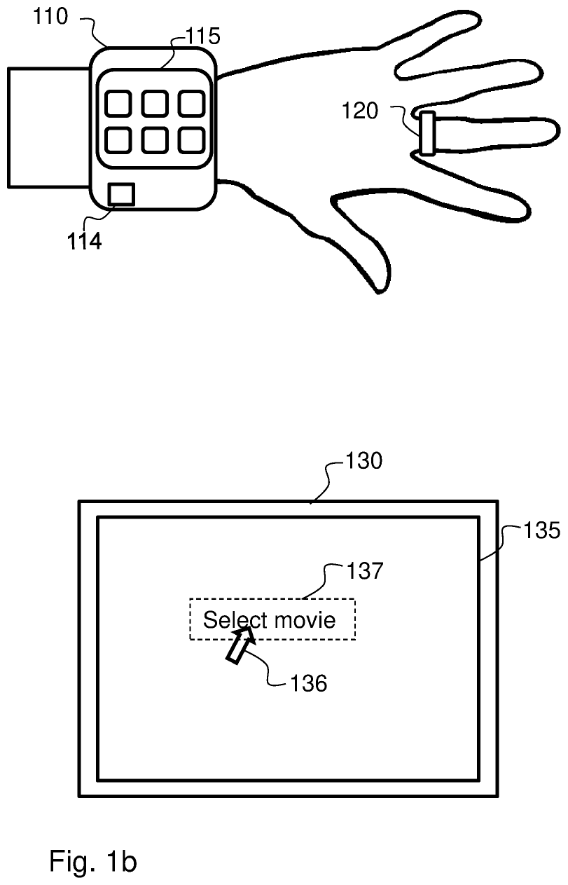

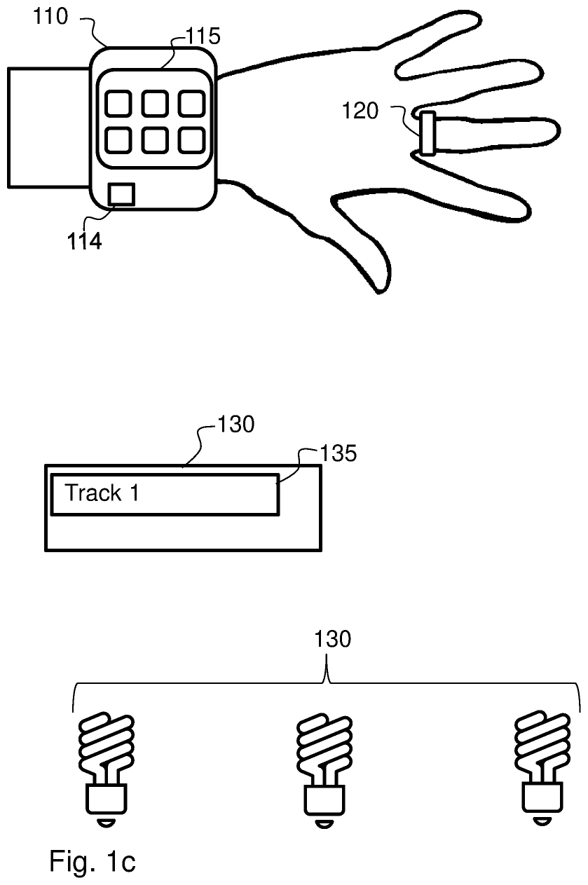

Embodiments herein relate to wearable electronic devices. In particular, embodiments herein relate to an electronic device system comprising a plurality of wearable electronic devices. FIG. 1a depicts such an electronic device system 100 comprising a wearable electronic device 110 and an electronic ring-shaped device 120.

The wearable electronic device 110 may be any of a watch, a smart band, a mobile phone, a headset, electronic clothing and electronic eyewear or any combination of the smart watch, the mobile phone, the headset, electronic clothing and the electronic eyewear. In some embodiments herein the wearable electronic device is configured to be worn on a wrist of an arm. This may be the case when the wearable electronic device 110 is a watch, a smart band, such as an electronic wrist band. The wearable electronic device 110 may also be an electronic fitness band. In FIG. 1 the wearable electronic device 110 is illustrated with a front side of a smart watch.

The wearable electronic device 110 comprises a motion sensor 114. The motion sensor 114 may be any of an Inertial Measurement Unit, IMU, and a magnetic sensor. The IMU may be a gyro or an accelerometer. The magnetic sensor may be a magnetic field sensor or a magnetometer. The motion sensor 114 may provide data about the motion of the wearable electronic device 110.

In some embodiments the wearable electronic device 110 further comprises a graphical user interface, GUI, e.g., for controlling and/or interaction with the wearable electronic device 110. For example, the GUI of the wearable electronic device 110 may comprise one or more touch sensors for controlling the wearable electronic device 110. The GUI may be presented on a display 115, e.g., on the front side of the wearable electronic device 110.

The wearable electronic device 110 may further comprise one or more physical buttons which are not illustrated in FIG. 1.

As mentioned above, it may be of importance in some scenarios to be able to operate the wearable electronic device 110 with one hand, specifically the hand which the wearable electronic device 110 is attached to. Therefore, embodiments herein may use touch sensor data from the wearable electronic ring-shaped device 120 in combination with motions sensor data from the wearable electronic device 110 to control the wearable electronic ring-shaped device 120.

FIG. 1b also depicts the electronic device system 100, now further comprising a further electronic device 130 other than the wearable electronic device 110 and the electronic ring-shaped device 120. The further electronic device 130 will below be referred to as a third electronic device 130 since the wearable electronic device 110 may be seen as a first electronic device and the electronic ring-shaped device 120 may be seen as a second electronic device. Some third electronic devices 130 may be wearable devices, while other third electronic devices 130 are not wearable. When the electronic device system 100 comprises the third electronic device 130, the UI that is controlled is a UI of the third electronic device 130. Further, the UI of the third electronic device 130 may be a GUI. In FIG. 1b the third electronic device 130 is illustrated as a smart TV comprising a display. Thus, the third electronic device 130 may comprise a display 135 which may present at least a part of the GUI. In some embodiments the display 115 of the wearable electronic device 110 is used to present at least a part of the GUI of the third electronic device 130.

However, the third electronic device 130 may be any electronic device that is remotely controllable by the wearable electronic device 110 via a UI. For example, the third electronic device 130 may be any one or more of an Internet-of-Things device, a television, a computer, a mobile phone such as a smartphone, an audio player, a headset, a light system, a thermostat and a drone.

The wearable electronic device 110 may control the third electronic device 130 remotely via wireless communication, such as via radio-frequency communication. The wearable electronic device 110 may for example control the third electronic device 130 via a Bluetooth connection or Wi-Fi or similar. In some embodiments the wearable electronic device 110 communicate directly with the third electronic device 130, while in some other embodiments the wearable electronic device 110 communicates with the third electronic device 130 via some further device, such as a smartphone or a Wi-Fi router.

FIG. 1c illustrates further examples of the third electronic device 130, such as an audio player and a light system, that may be controlled by the wearable electronic device 110. In some embodiments the display 115 of the wearable electronic device 110 is used to present at least a part of the UI of the third electronic device 130. For example, if the audio player and/or the light system comprise a rudimentary or no GUI then the display 115 of the wearable electronic device 110 may be used to present at least a part of the UI of the third electronic device 130. In other embodiments, non-graphical UIs may be used to provide feedback to a user. For example, audio feedback to the user may be given through the audio player and/or the wearable electronic device 110. Similarly, with the light system illustrated in FIG. 1c feedback may be given by audio, e.g., by the wearable electronic device 110, and/or through the light intensity or the light colour of the light system or any other parameter of the light system that results in a change of the visual perception of the light from the light system.

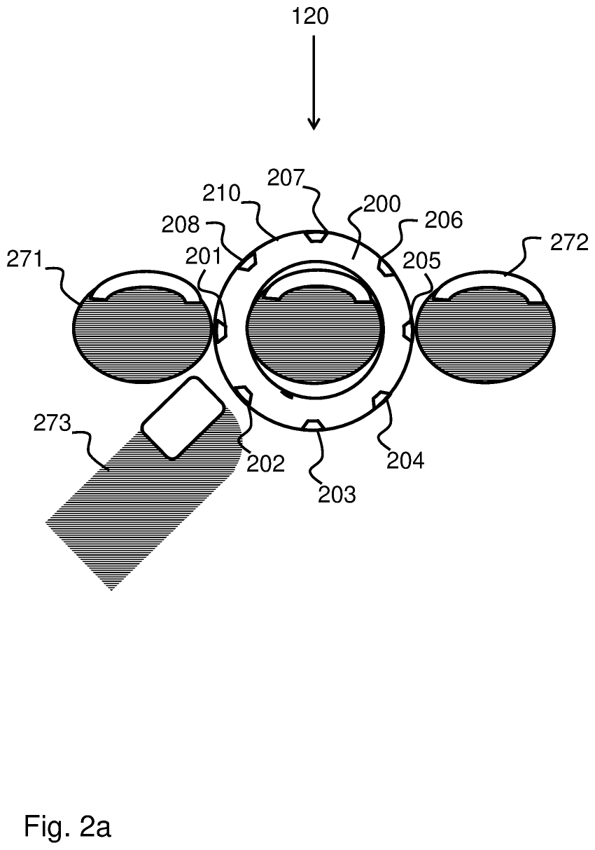

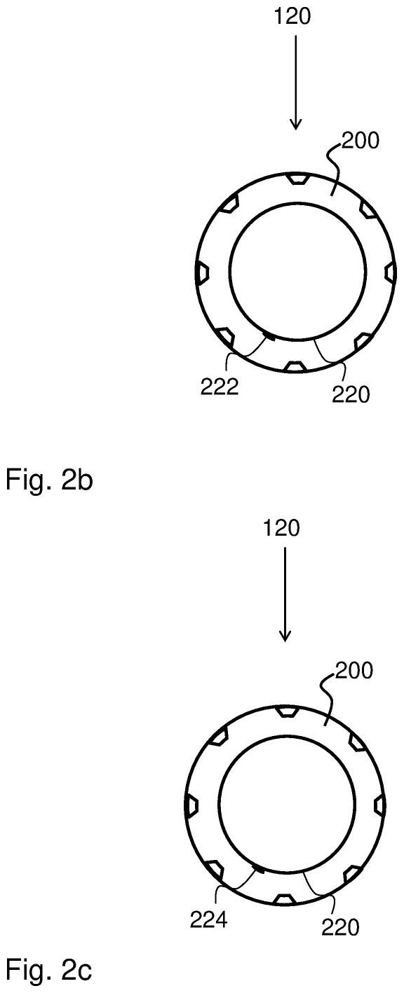

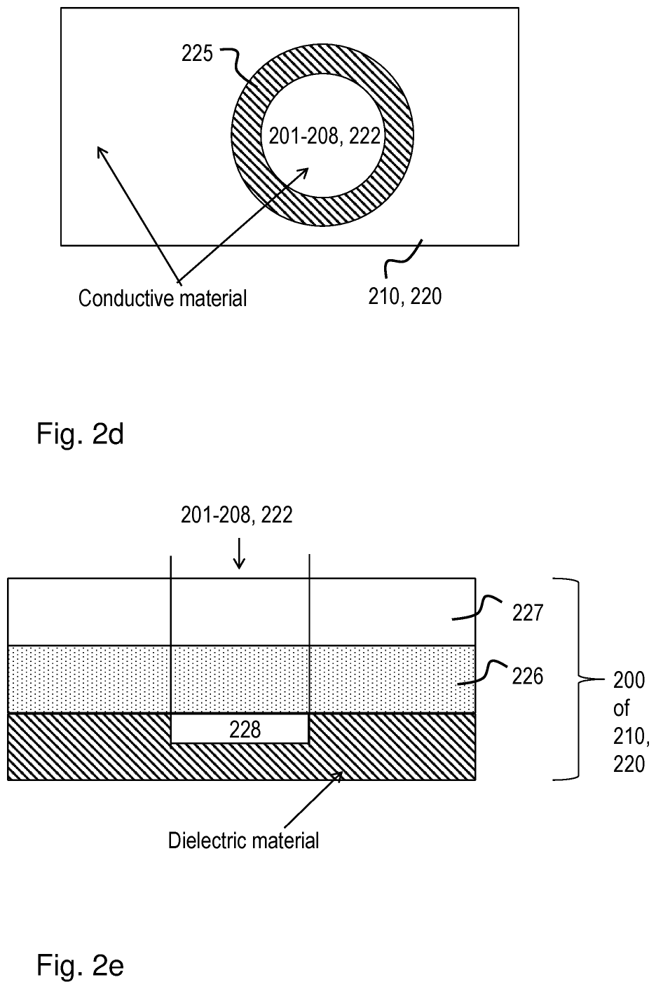

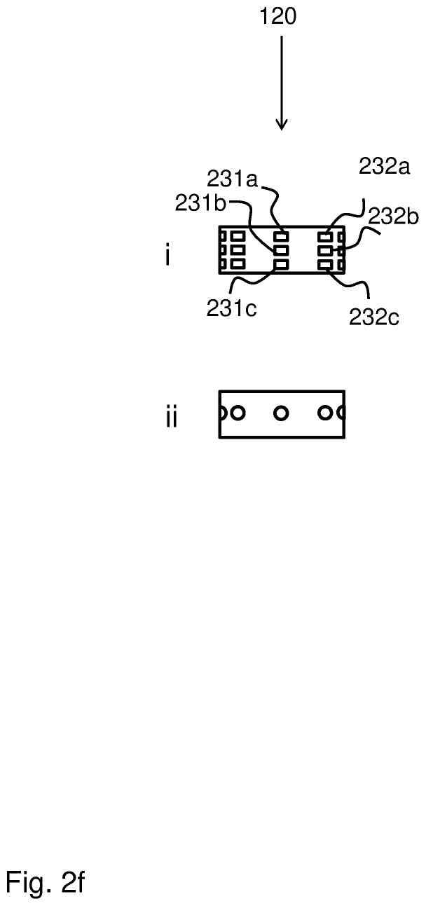

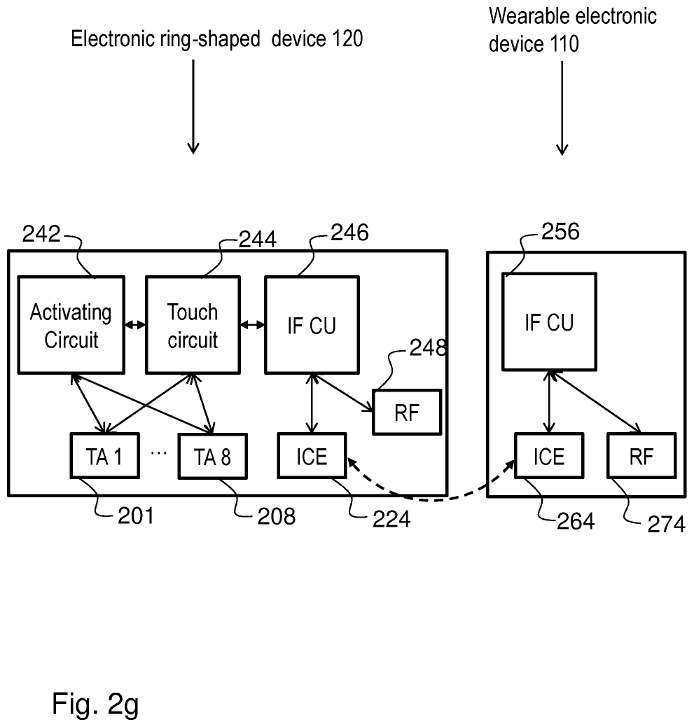

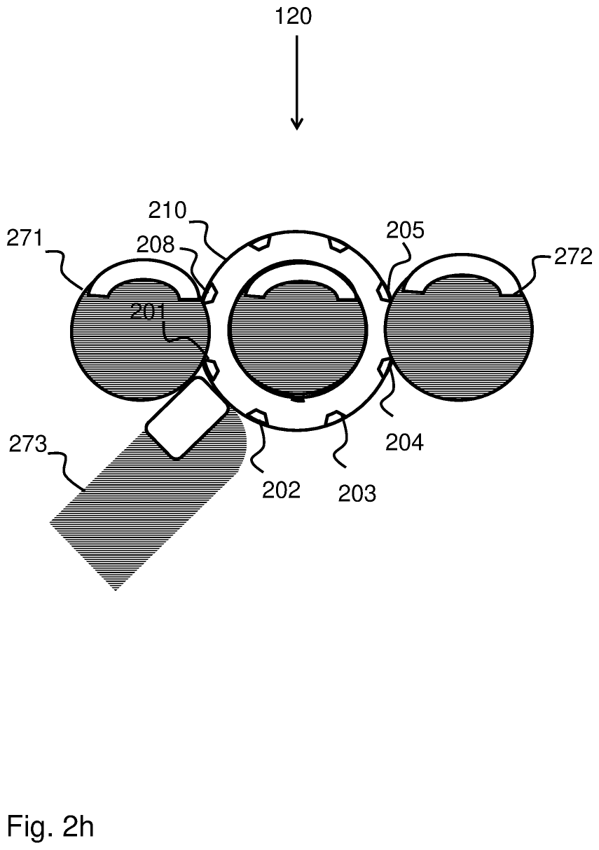

FIG. 2a illustrates an embodiment of the electronic ring-shaped device 120. The electronic ring-shaped device 120 may comprise a ring-shaped mechanical structure 200 adapted to be fitted to a finger. Different electronic devices which will be presented below may be arranged within the ring-shaped mechanical structure 200. For example, the electronic ring-shaped device 120 comprises one or more touch sensors 201-208, 222.

In some embodiments the electronic ring-shaped device 120 comprises a plurality of outer touch sensitive areas 201-208 arranged on an outer face 210 of the electronic ring-shaped device 120. The outer touch sensitive areas 201-208 may be capacitive touch sensitive areas. As an example, the electronic ring-shaped device 120 is illustrated in FIG. 2a as comprising eight outer touch sensitive areas: a first outer touch sensitive area 201, a second outer touch sensitive area 202, a third outer touch sensitive area 203, a fourth outer touch sensitive area 204, a fifth outer touch sensitive area 205, a sixth outer touch sensitive area 206, a seventh outer touch sensitive area 207, and an eight outer touch sensitive area 208.

The outer face 210 may be an outer face of the mechanical structure 200. The outer touch sensitive areas 201-208 may also be referred to as touch sensors or outer touch sensors. An object interacting with a capacitive touch sensor influences a capacitance of the touch sensor. The influence may be measured for example by measuring the capacitance of the capacitive touch sensor or other related parameters.

Thus, in some embodiments the one or more touch sensors 201-208 are arranged on an outer face 210 of the electronic ring-shaped device 120.

As illustrated in FIG. 2b, the electronic ring-shaped device 120 may further comprise an inner face 220 on which an inner touch sensitive area 222 may be arranged. The inner face 220 may be an inner face of the mechanical structure 200.

In some embodiments there are multiple inner touch sensitive areas arranged on the inner face 220. The inner touch sensitive area 222 may also be a capacitive touch sensitive area. The inner touch sensitive areas 222 may also be referred to as a touch sensor or as an inner touch sensor.

Thus, the one or more touch sensors 201-208, 222 may comprise one or more capacitive touch sensors.

As illustrated in FIG. 2c, the wearable electronic ring-shaped device 120 may further comprise a communication electrode 224, such as an Internal Communication Electrode (ICE), for communication with the wearable electronic device 110. The communication electrode 224 may be arranged on the inner face 220 of the electronic ring-shaped device 120. The communication electrode 224 may also function as the inner touch sensitive area 222. However, in some other embodiments the inner touch sensitive area 222 is separate from the communication electrode 224. In some embodiments there are multiple communication electrodes arranged on the inner face 220.

Since a scenario in which embodiments herein may be implemented is that the wearable electronic device 110 is arranged on a same limb as the electronic ring-shaped device 120 the communication power may be kept low. For example, the communication may be done through a body area network, e.g., with in-body communication (IBC), or a low-power radio, such as Bluetooth Low Energy (BLE). IBC may also be referred to as human-body communication (HBC).

FIG. 2d illustrate details of some embodiments of the electronic ring-shaped device 120. More specifically, FIG. 2d illustrates a part of the outer face 210, including one of the outer touch sensitive areas 201-208, of the electronic ring-shaped device 120. In FIG. 2d the electronic ring-shaped device 120 is at least partly made of a conductive material, such as metal. For example, the ring-shaped mechanical structure 200 may at least partly be made of the conductive material, such as metal. Then the touch sensitive areas 201-208, 222 may be protected by a dielectric material structure 225. For example, it is possible to combine metal and plastic molds to achieve such a design.

FIG. 2e illustrate details of some other embodiments of the electronic ring-shaped device 120. More specifically, FIG. 2e illustrates a cut through a part of the electronic ring-shaped device 120, including one of the touch sensitive areas 201-208, 222. In FIG. 2e the electronic ring-shaped device 120 comprise three different parts, such as three different material layers, within the touch sensitive area. For example, the ring-shaped mechanical structure 200 may comprise one or more of the three different parts.

In some examples, a dielectric material part 226 may be arranged between two conductive material parts 227 and 228. The dielectric material part 226 may be made of a dielectric compressible material. Then it is possible to measure the capacitive change between the two conductive materials.

Further, any wiring comprised in the electronic ring-shaped device 120 and needed for the operation of the electronic ring-shaped device 120 may be isolated from any other wiring and from other metal parts of the electronic ring-shaped device 120. A dielectric material may provide the isolation.

In other embodiments the ring-shaped mechanical structure 200 is made from an isolating material, such as plastic.

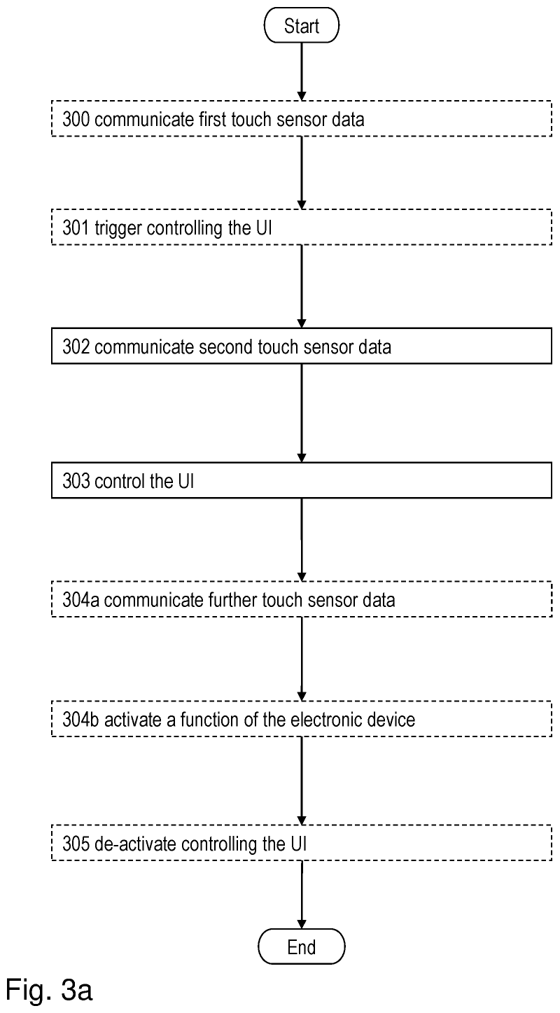

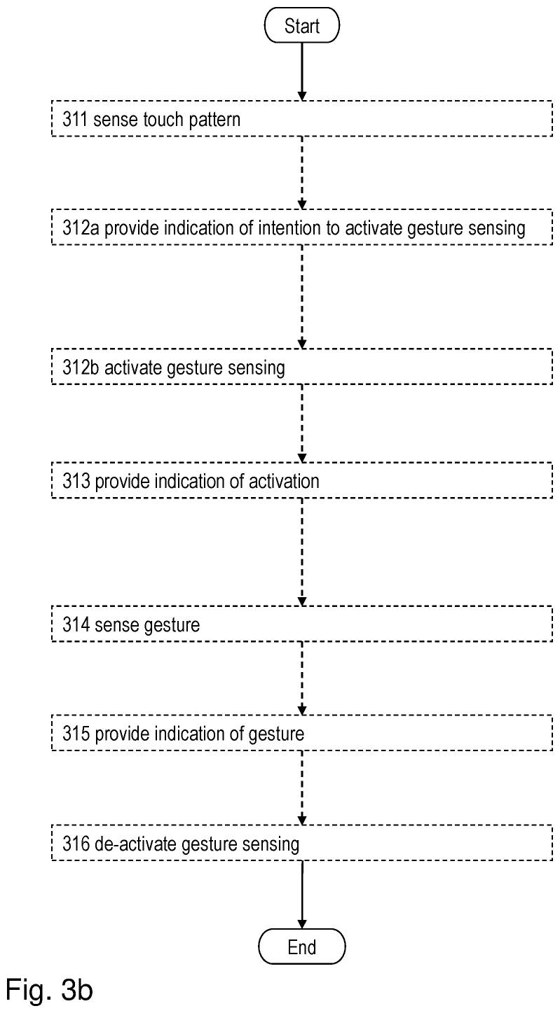

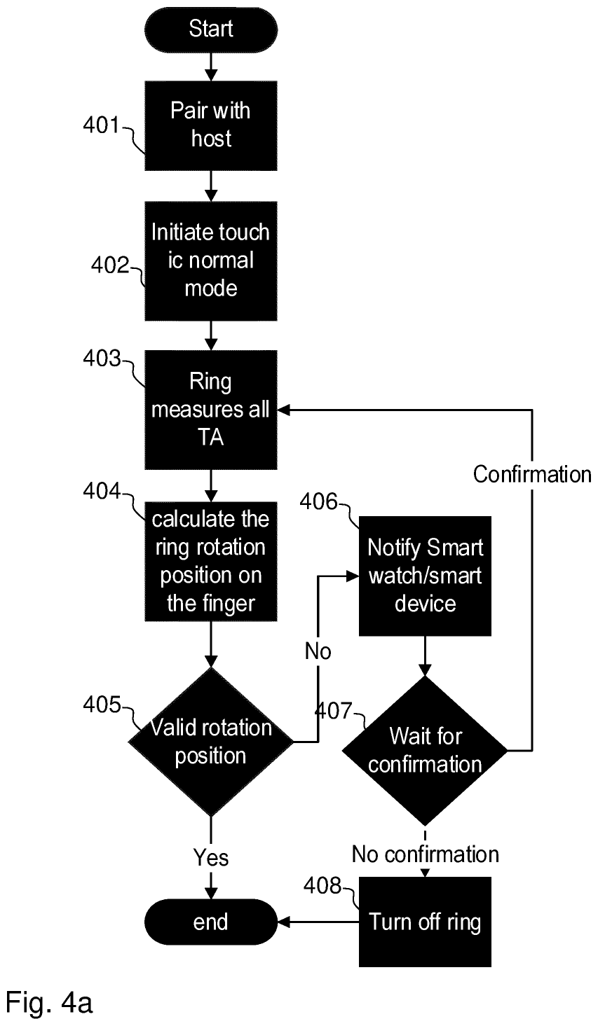

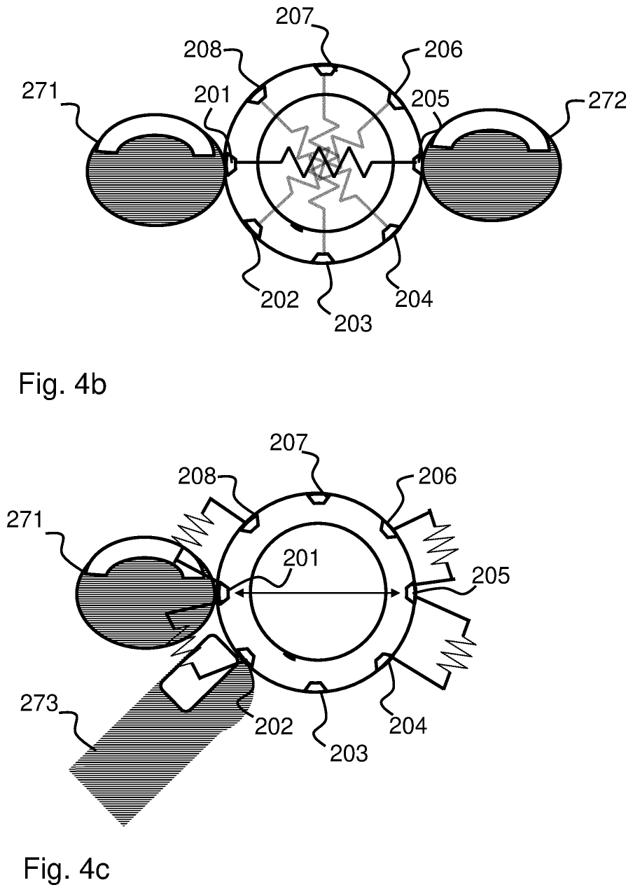

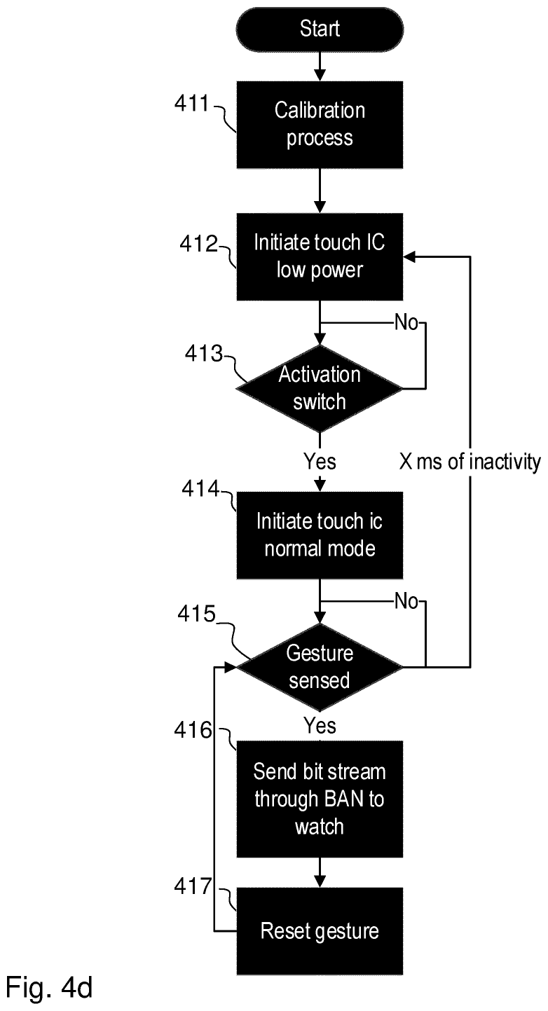

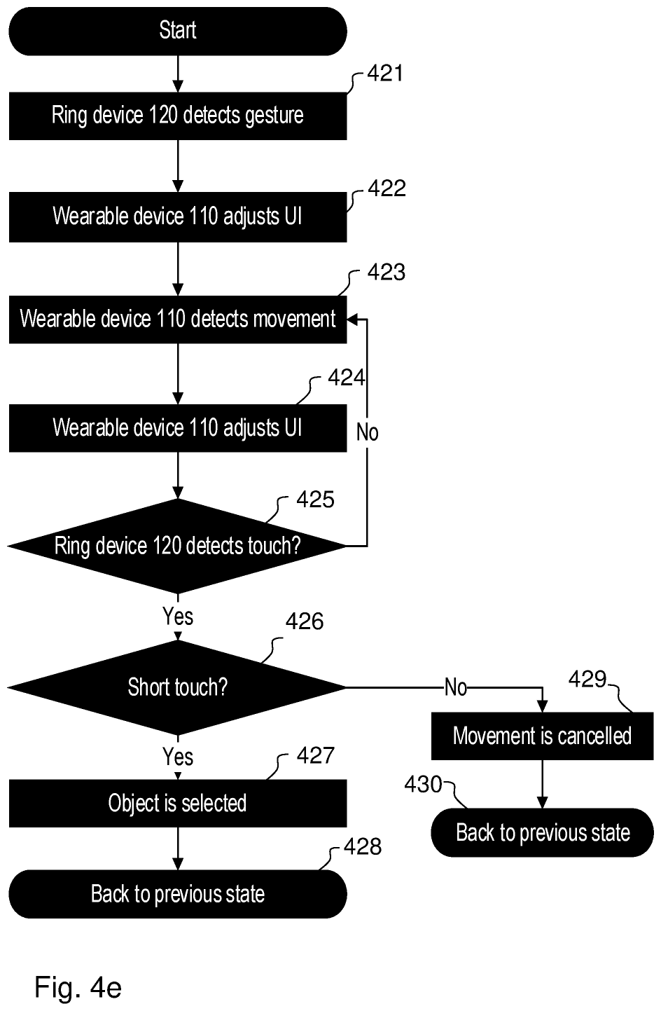

FIG. 2f illustrates different ring designs. In embodiments herein a ring design relates to a shape of the one or more outer touch sensitive areas 201-208 and a distribution of them on the outer face 210 of the ring-shaped device 120. The electronic ring-shaped device 120 may have different designs depending on the application. In FIG. 2f two different ring designs are shown. A first ring design i is a matrix solution with the possibility to have a two-dimensional touch surface comprised of touch sensitive areas spread out in two dimensions. This may enable more gestures and thus more possibilities to interact with another different device, such as the wearable electronic device 110. Since outer touch sensitive areas 231a-c, 232a-c, are separated the design of such ring-shaped devices will be larger than a second ring design ii which is more suitable for detecting swipe gestures or one-dimensional touches. The second ring design ii may for example be used with the exemplifying embodiments described below in relation to FIG. 3b and FIGS. 4a and 4d. Adding another dimension, as in the first ring design, a bit length of a gesture identifier may need to be longer.

FIG. 2g illustrates components which may be internal to the ring-shaped device 120 and their communication paths indicated with arrows. FIG. 2g further illustrates with arrows how the components are connected to the outer touch sensitive areas 201-208. In some embodiments herein the electronic ring-shaped device 120 comprises an activating circuit 242 electrically connected to each outer touch sensitive area 201-208.

The activating circuit 242 may further be electrically connected to one or more inner touch sensitive areas 222.

The activating circuit 242 may also be referred to as an activation switch. The activating circuit 242 may be implemented as an integrated circuit, IC.

The activating circuit 242 may be configured to sense a touch pattern with the touch sensitive area 201-208 and based on the sensed touch pattern activate or trigger the electronic ring-shaped device 120 to sense one or more gestures with the outer touch sensitive area 201-208. In other words, the activating circuit 242 may trigger if an event triggering gesture sensing has happened. The sensed gestures may be used to control another electronic device such as the wearable electronic device 110. For example, the activating circuit 242 may activate a touch circuit 244 electrically connected to each outer touch sensitive area 201-208 and configured to sense the gesture, such as a gesture to control the wearable electronic device 110. The touch circuit 244 may further be electrically connected to one or more inner touch sensitive areas 222.

In other words, the activating circuit 242 may trigger the touch circuit 244 if a specific triggering touch pattern has been sensed.

In some embodiments herein sensing the touch pattern which activates the gesture sensing is based on a resistance measurement between two outer touch sensitive areas, such as between the first outer touch sensitive area 201 and the second outer touch sensitive area 202 and/or between the first outer touch sensitive area 201 and the fifth outer touch sensitive area 205, out of the plurality of outer touch sensitive areas 201-208.

The resistance measurement may be made between more than two outer touch sensitive areas 201, 202 out of the plurality of outer touch sensitive areas 201-208. This will be explained in more detail below when describing action 301.

As mentioned above, the electronic ring-shaped device 120 may further comprise the touch circuit 244 electrically connected to each touch sensitive area 201-208, 222 and configured to sense the gesture when activated e.g., by the activating circuit 242. The touch circuit 244 may be implemented as a touch IC. The touch circuit 244 reads sensor data and interprets the sensor data from the touch sensitive area 201-208 in order to determine a gesture based on the sensor data. For example, the touch circuit 244 may sense the gesture by detecting changes in a measure related to a capacitance of a respective one of the plurality of outer touch sensitive areas 201-208. In other words, a capacitive touch IC may be used to be able to sense different combinations of capacitive changes and interpret them so that different gestures on the ring may be determined.

The touch circuit 244 may further control power of the touch sensitive area 201-208.

The touch circuit 244 may be electrically connected to the activating circuit 242 such that it can be activated by the activating circuit 242.

In some embodiments herein the touch circuit 244 comprises the activating circuit 242. Thus, the activating circuit 242 may be a low power feature of the touch circuit 244.

In some embodiments herein the electronic ring-shaped device 120 further comprises an interface communication unit (IF CU) 246. The IF CU 246 may be a hardware component that gets the gesture data from the touch circuit 244 and communicates the gesture data, e.g., through the communication electrode 224, to other devices, such as the wearable electronic device 110, worn by the user.

The communication technology used by the IF CU 246 may be any communication technology. However as mentioned above, in the scenario where the electronic ring-shaped device 120 controls the wearable electronic device 110 which is in proximity of the electronic ring-shaped device 120 then the communication may be done through IBC or low-power radio in order to reduce the power consumption. For example, the IF CU 246 may be connected with a radio antenna 248, comprised in the electronic ring-shaped device 120, which communicate wirelessly with other radio antennas.

The electronic components of the electronic ring-shaped device 120 may operate based on electrical power from a battery comprised in the electronic ring-shaped device 120. The electronic ring-shaped device 120 may further include electrical wires to electrically connect the electrical components of the electronic ring-shaped device 120 for power transfer and communication. In some other embodiments the electrical power and/or the communication is implemented wirelessly.

FIG. 2g further illustrates components which may be internal to the wearable electronic device 110. In some embodiments the wearable electronic device 110 comprises an interface communication unit 256. The IF CU 256 of the wearable electronic device 110 may be a hardware component that gets the gesture data from the electronic ring-shaped device 120 and communicates the gesture data to the wearable electronic device 110 and possibly to further wearable electronic devices worn by the user.

The wearable electronic device 110 may further comprise a communication electrode 264, such as an ICE, for communication with the electronic ring-shaped device 120. The communication electrode 264 may be arranged on a face of the wearable electronic device 110 that is arranged for touching the skin of the user. For example, the communication electrode 264 may be arranged on the backside of the wearable electronic device 110.

The wearable electronic device 110 may be implemented with the same communication technology as the electronic ring-shaped device 120. Thus, the IF CU 256 and the communication electrode 264 may also use IBC. In some other embodiments the IF CU 256 use low-power radio, such as BLE. For example, the IF CU 256 may be connected with a radio antenna 274, comprised in the wearable electronic device 110, which communicate wirelessly with other radio antennas, such as the radio antenna 248 of the electronic ring-shaped device 120.

Some embodiments herein will now be described in relation to a first scenario where the electronic ring-shaped device 120 is configured to control the GUI of the wearable electronic device 110 by sensing touch and gestures with the touch sensitive areas 201-208, 222.

Some other embodiments herein will also be described in relation to a second scenario where the electronic ring-shaped device 120 is configured to control the UI of the third electronic device 130 by sensing touch and gestures with the touch sensitive areas 201-208, 222.

The electronic ring-shaped device 120 may be configured to trigger gesture sensing, such as touch-gesture sensing, with the electronic ring-shaped device 120. An indication of this trigger may be communicated to the wearable electronic device 110. Further, the sensed gestures may be communicated to the wearable electronic device 110 and the wearable electronic device 110 may use the sensed gesture to control the UI of the third device 130 or to control the GUI presented on the display 115 of the wearable electronic device 110. Triggering of the gesture sensing by a pre-determined touch pattern reduces the risk of unwillingly controlling the wearable electronic device 110.

Such a system also provides a power efficient interface to control a smart watch or a smart band with the ring-shaped device 110, e.g., by use of capacitive sensing.

In embodiments herein the control of the UI of the wearable electronic device 110 at least partly by the ring-shaped device 120 may also be referred to as a ring UI mode.

Exemplifying embodiments herein will now be described with reference to FIG. 3a and with further reference to FIGS. 1 and FIGS. 2a-g. FIG. 3a illustrates a flowchart describing a method, performed by the wearable electronic device 110, for controlling the UI. In some embodiments herein the UI that is controlled is the GUI of the wearable electronic device 110. In some other embodiments the UI that is controlled is a UI of the third electronic device 130. In some embodiments herein the UI of the third electronic device 130 is a GUI. This may be the case when the third electronic device 130 comprises a display, for example in the case of a TV or a computer with a display.

One or more of the following actions presented in FIG. 3 may be performed in the following exemplifying order. In other examples, the order may differ from what is described below.

As mentioned above, the wearable electronic device 110 is configured to communicate with the electronic ring-shaped device 120 comprising the one or more touch sensors 201-208, 222.

### Action 300

In order to trigger one-handed operation of the wearable electronic device 110 the electronic ring-shaped device 120 may communicate a trigger indication. The trigger indication may be communicated when the electronic ring-shaped device 120 has sensed a specific touch pattern with the touch sensors 201-208, 222. Such triggering touch patterns will be described in more detail below when describing FIGS. 4a and 4d.

The electronic ring-shaped device 120 may communicate a first touch sensor data from the one or more touch sensors 201-208, 222 to the wearable electronic device 110.

In some embodiments herein, the ring-shaped device 120 senses the touch pattern of the electronic ring-shaped device 120 with at least two outer touch sensitive areas 201, 202 of the plurality of outer touch sensitive areas 201-208 arranged on the outer face 210 of the electronic ring-shaped device 120.

### Action 301

In some embodiments the wearable electronic device 110 triggers controlling the UI based on the touch sensor data from the one or more touch sensors 201-208, 222 of the electronic ring-shaped device 120 and further based on the motion sensor data based on some triggering signal. The triggering may be based on the first touch sensor data communicated from the electronic ring-shaped device 120 described above in action 300.

### Action 302

The electronic ring-shaped device 120 communicates a second touch sensor data from the one or more touch sensors 201-208, 222 to the wearable electronic device 110. The second touch sensor data may be used in combination with motion sensor data from the motion sensor 114 of the wearable electronic device 110 to control the GUI of the wearable electronic device 110. In some other embodiments the second touch sensor data is used in combination with motion sensor data from the motion sensor 114 of the wearable electronic device 110 to control the UI of the third electronic device 130.

The electronic ring-shaped device 120 may communicate the second touch sensor data as well as the first touch sensor data with the IF CU 246 of the electronic ring-shaped device 120, while the wearable electronic device 110 may receive the same touch sensor data with the IF CU 256 of the wearable electronic device 110. The communication electrodes 224, 264 may be used for the communication.

### Action 303

The wearable electronic device 110 then controls the UI based on touch sensor data, such as the second touch sensor data, communicated from the electronic ring-shaped device 120 and further based on motion sensor data from the motion sensor 114 of the wearable electronic device 110.

The touch sensor data originates from the touch sensors 201-208, 222 of the electronic ring-shaped device 120 and may comprise data identifying a tap, multi-tap, longer touch etc.

The touch sensor data may also comprise gesture data. The gesture data may for example comprise data identifying a swipe, such as a swipe to one side or the other side, or a circular movement on any of the outer touch sensors 201-208. The touch sensor data may also comprise combinations of the above.

In particular, controlling may be based on the second touch sensor data communicated from the electronic ring-shaped device 120.

In some embodiments controlling the UI comprises moving a cursor on a display of the UI, such as on the display 115 of the GUI of the wearable electronic device 110, and/or moving a content of the display, such as a content of the display 115 of the wearable electronic device 110. In some other embodiments controlling the UI comprises moving a cursor on the display 135 of the third electronic device 130, and/or moving a content of the display 135 of the third electronic device 130. For example, in FIG. 1b the wearable electronic device 110 may control a pointing arrow 136 of the GUI of the third electronic device 130 to move onto or in close proximity to a selectable area 137 of the display 135 of the third electronic device 130.

In some further embodiments controlling the UI comprises scrolling through items of the display 115, 135. Then the touch sensor data initiates the scrolling which is continued based on the motion sensor data.

In some embodiments herein, when the UI of the third electronic device 130 is controlled, then the wearable electronic device 110 may present information related to the UI of the third electronic device 130 on the display 115 of the wearable electronic device 110. Such information may for example be which device or UI that is controlled, and/or which parameter that is controlled and/or a current value of the parameter that is being controlled. With the example of FIG. 1b, the wearable electronic device 110 may present the following information: smart TV, select movie, Frost 2. With the example of FIG. 1c, the wearable electronic device 110 may present the following information: kitchen lights, light intensity, 90%. Another example with the audio system of FIG. 1c is: living room Bluetooth speakers, volume, 30%. This feedback to the user through the display 115 of the wearable electronic device 110 may continue during the method such that the display 115 of the wearable electronic device 110 is updated with the latest control information.

In other embodiments, e.g., when there is no GUI of the third electronic device 130 and/or the wearable electronic device 110, the feedback may be given by other feedback means such as audio feedback, visual feedback and sensory feedback or any combination of these feedback means. The visual feedback may for example be he light intensity or the light colour of the light system or any other parameter of the light system that results in a change of the visual perception of the light from the light system. Such non-graphical feedback may be provided by the wearable electronic device 110 and/or the third electronic device 130. In all feedback cases the feedback may be provided in real-time.

Since the electronic wearable electronic device 110 controls the UI based on the touch sensor data communicated from the electronic ring-shaped device 120 and further based on motion sensor data from the motion sensor 114 of the wearable electronic device 110 the navigation of the UI, such as the GUIs 115, 135, is made easier since it is possible to more easily control the UI through one-handed operation, for example with the arm and hand that the wearable electronic device 110 is arranged on.

For example, swiping through lists or navigating a menu is less limited compared to using only a prior art touch sensor, such as a touch pad, in the electronic ring-shaped device 120 to control the UI, due to their limited size in combination with the limited movement of the finger that touches the electronic ring-shaped device 120.

A further advantage of embodiments herein is that they reduce the risk for false positives when a gesture is detected by the one or more touch sensors of the electronic ring-shaped device 120.

A further advantage of embodiments herein is that the size of the electronic ring-shaped device is reduced since the motion sensor 114 resides in the wearable electronic device 110 that is controlled. This also reduces the power consumption of the electronic ring-shaped device 120.

### Action 304a

The electronic ring-shaped device 120 may also trigger activation of a function associated with a selected item. The selected item may be presented on the display 115, 135 of the GUI of the wearable electronic device 110 and/or the third electronic device 130. For example, the GUI of the wearable electronic device 110 may be controlled to highlight the selected item presented on the display 115 of the GUI based on the touch sensor data, such as the second touch sensor data and further based on the motion sensor data from the motion sensor 114 as described above. In another example, the GUI of the third electronic device 130 may be controlled to highlight the selected item presented on the display 135 of the GUI based on the touch sensor data, such as the second touch sensor data and further based on the motion sensor data from the motion sensor 114 as described above.

In yet further embodiments selection and activation of functions of the UI need not be associated with displayed items. For example, if the wearable electronic device 110 or the third electronic device 130 is a head set then the wearable electronic device 110 may control the audio volume by the method presented here. The audio volume may be controlled without displaying which parameter is controlled and without displaying the value of the parameter, in this case without displaying the value of the volume. Instead, audio feedback to the user may be given through the audio system of the headset.

Similarly, with the light system illustrated in FIG. 1c feedback may be given though the light intensity or the light colour or any other parameter that results in a change of the visual perception of the light.

Then the electronic ring-shaped device 120 may trigger activation of the function by sensing further touch sensor data, such as detecting touch on one or more of the touch sensors 201-208 and communicate the further touch sensor data to the wearable electronic device 110. The further touch sensor data may indicate or identify activation of the function, or a confirmation of the selection of the selected item presented on the display 115. The further touch sensor data may for example be a tap or a double tap.

### Action 304b

When the electronic ring-shaped device 120 has triggered activation of the function the wearable electronic device 110 activates the function based on the further touch sensor data from the electronic ring-shaped device 120.

If the function was presented on a display, such as on the display 115 of the GUI of the wearable electronic device 110, then when the electronic ring-shaped device 120 has triggered activation of the function the wearable electronic device 110 activates the function presented on the display 115 of the GUI of the wearable electronic device 110 based on the further touch sensor data from the electronic ring-shaped device 120.

FIG. 3b illustrates a flowchart describing an exemplifying method for triggering gesture sensing and for sensing gestures, performed by the electronic ring-shaped device 120.

### Action 311

In some embodiments herein the ring-shaped device 120 senses a touch pattern of the electronic ring-shaped device 120 with at least the first outer touch sensitive area 201 of the plurality of outer touch sensitive areas 201-208 arranged on the outer face 210 of the electronic ring-shaped device 120. In some embodiments herein, the ring-shaped device 120 senses the touch pattern of the electronic ring-shaped device 120 with at least two outer touch sensitive areas, such as the first outer touch sensitive area 201 and the second outer touch sensitive area 202 of the plurality of outer touch sensitive areas 201-208 arranged on the outer face 210 of the electronic ring-shaped device 120. Sensing the touch pattern may also be referred to as detecting the touch pattern or determining the touch pattern or determining whether or not the touch pattern has been applied to at least the first outer touch sensitive area 201.

Since the electronic ring-shaped device 120 may rotate freely around the finger there may be more than one configuration of the touch pattern that triggers the gesture sensing depending on the ring design. FIG. 2a illustrates one example of a ring rotation position or ring configuration. In FIG. 2a fingers next to the finger on which the electronic ring-shaped device 120 is arranged are only activating one outer touch sensitive area 201, 205 on each side of the electronic ring-shaped device 120. Here, the outer touch sensitive area 201, 205 on each side of the electronic ring-shaped device 120 is arranged on each side of the electronic ring-shaped device 120 with respect to the finger on which the electronic ring-shaped device 120 is arranged on. In that case, when a finger is positioned so that two consecutive outer touch sensitive area 201, 202 are activated the electronic ring-shaped device 120 may trigger the rest of the outer touch sensitive areas 201-208 to be able to detect a following gesture.

Thus, in FIG. 2a the electronic ring-shaped device 120 may detect a first touch on the first outer touch sensitive area 201 due to a first adjacent finger 271 and may detect a further touch on a further outer touch sensitive area 205 due to a second adjacent finger 272. The first adjacent finger 271 may be an index finger. The first and second adjacent fingers 271, 272 are adjacent to the finger that the electronic ring-shaped device 120 is arranged on. Sensing gestures may be triggered by detecting a third touch on the second outer touch sensitive area 202 or the third outer touch sensitive area 203 due to a third finger 273, such as a thumb. In FIG. 2a the second outer touch sensitive area 202 is adjacent to the first outer touch sensitive area 201, which is convenient for one-handed operation of the electronic ring-shaped device 120 with the thumb. The second outer touch sensitive area 202 and/or the third outer touch sensitive area 203 may further be arranged on a part of the electronic ring-shaped device 120 which is arranged closest to a palm of the hand wearing the electronic ring-shaped device 120 which is convenient for one-handed operation of the electronic ring-shaped device 120 with the thumb.

FIG. 2h illustrates another example of the ring rotation position or ring configuration. If the electronic ring-shaped device 120 is positioned like in FIG. 2h, the electronic ring-shaped device 120 will detect touches on a respective two touch sensitive areas 201, 208 and 204, 205 arranged on each side of the electronic ring-shaped device 120 with respect to the finger on which the electronic ring-shaped device 120 is arranged on. As the electronic ring-shaped device 120 detects touches on both sides the electronic ring-shaped device 120 will not trigger sensing of gestures. Only when a touch on a third consecutive outer touch area, such as the third outer touch sensitive area 203, is sensed the electronic ring-shaped device 120 is triggered to sense gestures.

Thus, in FIG. 2h the electronic ring-shaped device 120 may detect a first pair of touches on a first pair of outer touch sensitive areas 201, 208 due to the first adjacent finger 271 and detect a second pair of touches on a second pair of outer touch sensitive areas 204, 205 due to the second adjacent finger 272. Sensing gestures may be triggered by detecting a third pair of touches on a third pair of outer touch sensitive areas 201, 202 due to the third finger 273, such as the thumb.

In some embodiments herein the electronic ring-shaped device 120 keeps track of a respective signal from the outer touch sensitive areas 201-208 and will not trigger activation of gesture sensing if similar signals from the outer touch sensitive areas 201-208 are received from the two sides of the ring.

Once the electronic ring-shaped device 120 senses a third touch in proximity to either side of the outer touch sensitive areas 201-208 that already sense a touch, the electronic ring-shaped device 120 will trigger the electronic ring-shaped device 120 to sense gestures with the outer touch sensitive areas 201-208.

For example, if the activating circuit 242 senses a third touch in proximity to either side of the outer touch sensitive areas 201-208 that already sense a touch the activating circuit 244 will trigger the touch circuit 244 to wake up.

This method enables the electronic ring-shaped device 120 to be worn in any rotation as the third finger 273 may identify how the electronic ring-shaped device 120 is rotated. For example, if it is assumed that the third finger 273 is the thumb on the same hand then the knowledge of an anatomy of the hand and which finger the electronic ring-shaped device 120 is worn on may be used to identify how the electronic ring-shaped device 120 is rotated.

Once the ring orientation is found the outer touch sensitive areas 201-208 on the top of the electronic ring-shaped device 120 may be de-activated since the electronic ring-shaped device 120 may expect a touch from the inside of the palm of the hand on which the electronic ring-shaped device 120 is arranged on. The bottom of the electronic ring-shaped device 120 may be defined as a half part of the electronic ring-shaped device 120 which is closer to the palm than the other half part. The top of the ring may thus be defined as a half part of the electronic ring-shaped device 120 which is furthest away from the palm than the other half part.

The embodiments described in relation to FIG. 2a and FIG. 2h may be combined. For example, after detection of the first touch and the further touch as described in relation to FIG. 2a the electronic ring-shaped device 120 may detect the pair of touches on the third pair of outer touch sensitive areas 201, 202 due to the third finger 273. Alternatively, after detection of the first and second pair of touches as described in relation to FIG. 2h the electronic ring-shaped device 120 may detect a further touch on for example the second outer touch sensitive area 202 due to the third finger 273.

Based on the above example scenarios further embodiments may be defined according to the following text.

In some embodiments herein the touch pattern comprises at least two simultaneous separate touches. That is, the touch pattern may comprise a respective touch on at least two touch sensitive areas 201, 202. The two touches may be due to touch by two fingers, e.g., a first touch with the first adjacent finger 271 and a second touch with the third finger 273.

Sensing the touch pattern may further comprise sensing a touch from two or more consecutive outer touch sensitive areas such as the first outer touch sensitive area 201 and the second outer touch sensitive area 202. That is, the consecutive outer touch sensitive areas 201, 202 may be adjacent touch sensitive areas meaning that the consecutive outer touch sensitive areas 201, 202 are arranged adjacently on the outer face 210 of the electronic ring-shaped device 120.

In some embodiments sensing the touch pattern comprises sensing an asymmetric response with the plurality of outer touch sensitive areas 201-208, wherein the asymmetric response comprises sensing touch with two or more outer touch sensitive areas 201, 202, 203 which are asymmetrically distributed on the outer face 210 of the electronic ring-shaped device 120.

In some embodiments herein sensing the touch pattern is based on a resistance measurement between two outer touch sensitive areas 201, 202 out of the plurality of outer touch sensitive areas 201-208. The resistance measurements may be made between more than two outer touch sensitive areas 201, 202 out of the plurality of outer touch sensitive areas 201-208.

With the ring orientation of FIG. 2a as an example, the electronic ring-shaped device 120 may first measure resistance between the first outer touch sensitive area 201 and the fifth outer touch sensitive area 205 to detect touch by the first finger 271 on the first outer touch sensitive area 201 and by the second finger 272 on the fifth outer touch sensitive area 205. Then the electronic ring-shaped device 120 may measure resistance between the first outer touch sensitive area 201 and the second outer touch sensitive area 202 to detect touch by the third finger 273 on the second touch sensitive area 202. In other words, the electronic ring-shaped device 120 may first measure resistance between outer touch sensitive areas arranged on opposite sides of the electronic ring-shaped device 120. If the first resistance measurement indicates that the outer touch sensitive areas arranged on opposite sides of the electronic ring-shaped device 120 are touched, then the electronic ring-shaped device 120 may continue to measure resistance between further outer touch sensitive areas. The further outer touch sensitive areas may for example be located adjacent to the outer touch sensitive areas arranged on opposite sides of the electronic ring-shaped device 120 and/or may be located on a palm side of the electronic ring-shaped device 120.

With the ring orientation of FIG. 2h as an example, the electronic ring-shaped device 120 may first measure resistance between the first outer touch sensitive area 201 and the eight outer touch sensitive area 208 to detect touch by the first finger 271 on the first and eighth touch sensitive areas 201, 208, and measure resistance between the fourth outer touch sensitive area 204 and the fifth outer touch sensitive area 205 to detect touch by the second finger 272 on the fourth and fifth touch sensitive areas 204, 205. Alternatively, or in combination, the electronic ring-shaped device 120 may also first measure resistance between outer touch sensitive areas arranged on opposite sides of the electronic ring-shaped device 120, such as between the first and fourth touch sensitive areas 201, 204, as described above for the ring orientation of FIG. 2a. If the first resistance measurement indicates that the outer touch sensitive areas arranged on opposite sides of the electronic ring-shaped device 120 are touched then the electronic ring-shaped device 120 may continue to measure resistance between further outer touch sensitive areas also for the ring orientation of FIG. 2h.

Sensing the touch pattern may be performed by the activating circuit 242.

Since the activating circuit 242 may be implemented as a low-power circuit the sensing of the touch pattern may be made with low power consumption.

Action 311 is related to action 300 above.

### Action 312a

In some embodiments the electronic ring-shaped device 120 provides an indication that it has sensed the touch pattern to the wearable electronic device 110. That is, the electronic ring-shaped device 120 may provide an indication of its intention to activate gesture sensing, for example to support the ring UI mode.

Action 312a is related to action 301 above.

### Action 312b

In response to sensing the touch pattern the electronic ring-shaped device 120 may activate the electronic ring-shaped device 120 to sense a gesture with one or more of the plurality of outer touch sensitive areas 201-208.

In some embodiments wherein the electronic ring-shaped device 120 comprises the touch circuit 244, activating the electronic ring-shaped device 120 to sense the gesture comprises activating the touch circuit 244 to sense the gesture.

For example, the touch circuit 244 may charge and discharge the touch sensitive areas 201-208 and may then measure a time to charge and discharge. A touch on the touch sensitive areas 201-208 changes the time to charge and discharge. The time may be measured to obtain a measure of the touch.

The activating circuit 242 may activate the electronic ring-shaped device 120 to sense the gesture.

In some embodiments herein the activating circuit 242 activates the touch circuit 244, in response to sensing the touch pattern, to sense the gesture.

By activating the electronic ring-shaped device 120 to sense a gesture the number of false positives may be reduced. That is, triggering of the gesture sensing by a pre-determined touch pattern reduces the risk of unwillingly controlling the wearable electronic device 110 by detecting a gesture and communicating it to the host device as a command for a case where the user did not intend to perform that command.

Activating the electronic ring-shaped device 120 to sense the gesture may further be based on an indication of a confirmation of the activation received from the wearable electronic device 110. The confirmation may be in response to the provided indication of the intention to activate gesture sensing. For example, if the electronic ring-shaped device 120 has provided the indication of the intention to activate gesture sensing (e.g., two quick vibrations), the wearable electronic device 110 may need to detect an additional gesture of the user to confirm the ring UI mode. The additional gesture may be a rapid tilt of the arm or hand back-and-forth. When the additional gesture has been detected by the wearable electronic device 110 it may communicate another notification to the electronic ring-shaped device 120 as confirmation (e.g., one quick vibration).

Activating the electronic ring-shaped device 120 to sense the gesture may further be based on data from the motion sensor 114 comprised in the wearable electronic device 110 or a motion sensor comprised in the electronic ring-shaped device 120. The motion sensor may be an IMU or an accelerometer or a magnetometer.

Activating the electronic ring-shaped device 120 to sense the gesture may further be based on an indication that the display 115 of the wearable electronic device 110 is active. The indication that the display 115 of the wearable electronic device 110 is active is received from the wearable electronic device 110. For example, the start trigger may only be enabled when the user interface of the wearable electronic device 110 is activated.

Activating the electronic ring-shaped device 120 to sense the gesture may further be based on touch data from the touch sensitive area 222 arranged on the inner face 220 of the electronic ring-shaped device 120.

In other words, inner touch sensitive areas 222 on the inner face 220 of the electronic ring-shaped device 120 may also be used in combination with the one or more outer touch sensitive areas 201-208 for activating the electronic ring-shaped device 120 to sense gestures with one or more of the plurality of outer touch sensitive areas 201-208 on the outer face 210.

The electronic ring-shaped device 120 may update settings of the activation function, such as pressure thresholds, by training on real touch patterns and receiving feedback from the wearable electronic device 110 or the user. In that way accidental triggering of the gesture sensing is reduced. For example, a closed fist may activate a different set of outer touch sensitive areas 201-208 than only the touch sensitive areas 201-208 required for triggering the gesture sensing and thus the control of the wearable electronic device 110.

### Action 313

In some embodiments the electronic ring-shaped device 120 provides an indication of activating the electronic ring-shaped device 120 to sense the gesture to the wearable electronic device 110. In some other embodiments the electronic ring-shaped device 120 provides the wearable electronic device 110 with an indication of its intention to activate gesture sensing. Then the activation may be confirmed or not by the wearable electronic device 110. In both cases above, this may be interpreted by the wearable electronic device 110 as a trigger for controlling the UI, such as the GUI of the wearable electronic device 110. Thus, action 313 is related to action 301 above.

### Action 314

The electronic ring-shaped device 120 may then sense the gesture with one or more of the plurality of outer touch sensitive areas 201-208. Sensing the gesture may also be referred to as detecting the gesture or determining that the gesture has occurred.

As mentioned above, the plurality of outer touch sensitive areas 201-208 may be capacitive touch sensitive areas. Then sensing the gesture may comprise sensing a change in a measure related to a capacitance of a respective one of the one or more of the plurality of outer touch sensitive areas 201-208. The measure related to the capacitance may be a change in time to charge and/or discharge the plurality of outer touch sensitive areas 201-208. For example, the touch circuit 244 may be configured to sense the gesture by sensing a change in the measure related to the capacitance.

In some embodiments herein the electronic ring-shaped device 120 senses the gesture with a second outer touch sensitive area 202 out of the plurality of outer touch sensitive areas 201-208 which second outer touch sensitive area 202 is arranged on the electronic ring-shaped device 120 within a fraction of a circumference of the electronic ring-shaped device 120 from the at least first outer touch sensitive area 201. The fraction may be a quarter or a third of the circumference of the electronic ring-shaped device 120. The fraction may be in both a clockwise direction and an anti-clockwise direction.

If multiple first outer touch sensitive areas 201, 202 are used to sense the touch pattern which triggers the gesture sensing, then the second outer touch sensitive area 202 may be arranged within the fraction of the circumference from any of the at least first outer touch sensitive areas 201, 202.

Specifically, the second outer touch sensitive area 202 may be arranged within the fraction of the circumference from the outer touch sensitive area 202 that sensed the third touch described above in relation to action 301.

The second outer touch sensitive area 202 may be arranged on a palm side of the electronic ring-shaped device 120. Thus, in some embodiments herein the second outer touch sensitive area 202 is arranged on the palm side of the electronic ring-shaped device 120 within the fraction of the circumference from any of the at least first outer touch sensitive areas 201, 202. In some further embodiments herein, the second outer touch sensitive area 202 is arranged on the palm side of the electronic ring-shaped device 120 within the fraction of the circumference from one of the at least first outer touch sensitive areas 201, 202 which is located on the palm side of the of the electronic ring-shaped device 120.

In some embodiments herein the electronic ring-shaped device 120 senses the gesture with multiple outer touch sensitive areas 202, 203 out of the plurality of outer touch sensitive areas 201-208. Then the multiple outer touch sensitive areas 202, 203 may be arranged on the electronic ring-shaped device 120 within the fraction of the circumference from the at least first outer touch sensitive area 201.

A description of how to select which outer touch sensitive areas that may be configured for gesture sensing is further described below in action 414.

The gesture calculation may be performed by the electronic ring-shaped device 120, for example by the touch circuit 244. Then the electronic ring-shaped device 120 may send a gesture identity to the wearable electronic device 110. This reduces the power consumption of the electronic ring-shaped device 120 and the wearable electronic device 110 since very little data needs to be transferred from the electronic ring-shaped device 120 to the wearable electronic device 110.

Action 314 is related to action 303 above.

### Action 315

In some embodiments herein the electronic ring-shaped device 120 provides an indication of the gesture to the wearable electronic device 110. The indication may identify the gesture. For example, a gesture identity (gesture ID) may be sent to the IF CU 256 of the wearable electronic device 110. This is done to keep the bit rate down and lower the power consumption. One example of a 3-bit gesture i.e., 8 different gestures may be identified, transfer scheme is the following:
1. Swipe left
2. Swipe right
3. Press
4. Long press
5. Swipe up
6. Swipe down
7. Two touch area press
8. Two touch area long press

Other bit lengths may also be used, such as 2 bits or 4 bits. The short press gesture (2. press) may be comparable with a tap. A double tap may also be detected and potentially sent as one command to the smart watch.

Since a scenario in which embodiments herein may be implemented is that the wearable electronic device 110 is arranged on a same limb as the electronic ring-shaped device 120 the communication power may be kept low. For example, the communication may be done through a body area network, e.g., with IBC, or a low-power radio, such as BLE.

As mentioned above the electronic ring-shaped device 120 may comprise the ICE 224 on the inner face 220 of the electronic ring-shaped device 120. Then the ICE 224 may be used to communicate with the wearable electronic device 110 via in-body communication, IBC.

Action 315 is related to action 303 above.

### Action 316

The electronic ring-shaped device 120 may de-activate the electronic ring-shaped device 120 to sense the gesture in response to not sensing the gesture during a time period.

Action 316 is related to action 305 above.

### Further Detailed Examples

Further embodiments will now be described with respect to flow charts in FIG. 4a, FIG. 4d and FIG. 4e.

One or more of the following actions presented in FIGS. 4a-c may be performed in the following exemplifying order. In other examples, the order may differ from what is described below.

The electronic ring-shaped device 120 may be turned on once the electronic ring-shaped device 120 is put on the finger.

The electronic ring-shaped device 120 may be turned on once the electronic ring-shaped device 120 is put on the finger.

Further, a pairing procedure to pair the electronic ring-shaped device 120 with another electronic device, such as the wearable electronic device 110 may be performed when the ring-shaped device 120 is put on the finger. The paring may be performed either by IBC, or any other low-power interface that could be used. Pairing using IBC is effective since both devices are positioned on the same arm and in close proximity and this may be done automatically. If there is no response from the host the pairing will be aborted. The wearable electronic device 110 may be the host.

If the electronic ring-shaped device 120 is removed from the finger, or if the wearable electronic device 110, such as a smart watch, is removed from the arm, the pairing may be ended.

FIG. 4a illustrates a calibration process of the electronic ring-shaped device 120.

### Action 401

The calibration process may comprise the pairing procedure described above.

Calibration may be needed if some time has elapsed since last usage, or if the ring-shaped device 120 has rotated since the last calibration.

### Action 402

After pairing gesture sensing is enabled. For example, the touch circuit 244 powers up in normal mode wherein it may sense gestures with one or more touch sensitive areas 201-208.

### Action 403

In some embodiments herein the electronic ring-shaped device 120 senses touch with some or all outer touch sensitive areas 201-208 in order to be able to calibrate the rotation. In other words, depending on the rotation of the electronic ring-shaped device 120, the electronic ring-shaped device 120 may scan some or all of the outer touch sensitive areas 201-208 for detecting touch in an activation mode. In one example method of calibrating the rotation of the electronic ring-shaped device 120, the electronic ring-shaped device 120 behaves like a state machine.

In an example illustrated in FIG. 4b, the electronic ring-shaped device 120 measures resistance between two of the outer touch sensitive areas 201-208 on opposing sides of the electronic ring-shaped device 120, such as between the first outer touch sensitive area 201 and the fifth outer touch sensitive area 205. This is indicated in FIG. 4b by the resistor symbol. In FIG. 4b there are 4 pairs of touch sensitive areas on opposing sides: the first outer touch sensitive area 201 and the fifth outer touch sensitive area 205, the second outer touch sensitive area 202 and the sixth outer touch sensitive area 206, the third outer touch sensitive area 203 and the seventh outer touch sensitive area 207 and the fourth outer touch sensitive area 204 and the eighth outer touch sensitive area 208. Thus, four measurements of resistance between opposing outer touch sensitive areas may be made. When the first and second fingers 271, 272 touch the first and fifth outer touch sensitive areas 201, 205, as illustrated in FIG. 4b, the resistance between these outer touch sensitive areas may go down such that it is considerably lower than for the other opposing pairs of outer touch sensitive areas. This will indicate that the electronic ring-shaped device 120 is on a finger and it may also give a first indication of the rotation. Thus, it may be determined that the first and second fingers 271, 272 touch the first and the fifth outer touch sensitive areas 201, 205 by measuring the resistance according to the above scheme, e.g., by measuring the resistance between a respective pair of the outer touch sensitive areas 201-208 on opposing sides of the electronic ring-shaped device 120. That is, the two outer touch sensitive areas that make up the respective pair are arranged on opposing sides of the electronic ring-shaped device 120.

A next state is to check what side is towards the palm. This is illustrated in FIG. 4c. That may be done by checking a resistance between a respective one of the two opposing outer touch sensitive areas which were determined to be touched by the first and second fingers 271, 272 above and the outer touch sensitive areas next to the determined two opposing outer touch sensitive areas. The determined two opposing outer touch sensitive areas are indicated in FIG. 4b with a double-headed arrow. For example, as illustrated in FIG. 4c the electronic ring-shaped device 120 may measure the resistance between the first outer touch sensitive area 201 and the second outer touch sensitive area 202, between the first outer touch sensitive area 201 and the eighth outer touch sensitive area 208, between the fifth outer touch sensitive area 205 and the fourth outer touch sensitive area 204 and between the fifth outer touch sensitive area 205 and the sixth outer touch sensitive area 206. When the third finger 273 touches the second outer touch sensitive area 202 while the first finger 271 touches the first outer touch sensitive area 201, as illustrated in FIG. 4c, the resistance between the first outer touch sensitive area 201 and the second outer touch sensitive area 202 may go down such that it is considerably lower than for the other pairs of outer touch sensitive areas for which the resistance measurements of FIG. 4c apply, such as the first and eight, the fifth and fourth, and the fifth and sixth.

Then when the electronic ring-shaped device 120 has determined what part is towards the palm that may then trigger the touch circuit 244 to activate the outer touch sensitive areas towards the palm, such as the second outer touch sensitive area 202, the third outer touch sensitive area 203 and the fourth outer touch sensitive area 204 for gesture recognition. This is related to the description of FIG. 4d and actions 413 and 414 below.

### Action 404

Then the calibration process may determine the rotation of the electronic ring-shaped device 120 on the finger to determine what configuration the activating circuit 242 should be set to. The determination of the rotation configuration may be based on the measurements of touch performed in action 403 above. A couple of example rotation configurations have been described above. For example, the electronic ring-shaped device 120 arranged according to FIG. 2b may correspond to a first configuration while the electronic ring-shaped device 120 arranged according to FIG. 2c may correspond to a second configuration. The activation of the gesture sensing by the activating circuit is described further in action 413 below.

### Action 405

In some embodiments the electronic ring-shaped device 120 checks whether the rotation position is valid. For example, if the distribution of the outer touch sensitive areas 201-208 with respect to the first and second adjacent fingers is asymmetric, then the rotation position may be invalid. An invalid rotation position may lead to that touch from the first and second adjacent fingers is not sensed as a symmetric touch pattern.

### Action 406

The electronic ring-shaped device 120 may notify the wearable electronic device 110 about the invalid rotation position such that the wearable electronic device 110 may notify the user about the invalid rotation position. The user may then adjust the rotation of the electronic ring-shaped device 120.

### Action 407

When the wearable electronic device 110 has been notified of the invalid rotation position the electronic ring-shaped device 120 waits for confirmation from the wearable electronic device 110. The confirmation may comprise an indication that the wearable electronic device 110 is paired and is ready to be controlled. The confirmation may be based on user input.

### Action 408

If no confirmation is received from the wearable electronic device 110 the electronic ring-shaped device 120 may be turned off.

A process flow of controlling the wearable electronic device 110 based on sensed gestures by the electronic ring-shaped device 120 is shown in FIG. 4d.

### Action 411

The electronic ring-shaped device 120 may calibrate the rotation as described above in relation to FIG. 4a.

### Action 412

After a successful calibration process the electronic ring-shaped device 120 is put in a low power state and waits for the activating circuit 242 to trigger gesture sensing. Setting the electronic ring-shaped device 120 in the low-power state may comprise setting any of the outer touch sensitive areas 201-208, the touch circuit 244 and the IF CU 246 in a low-power state.

### Action 413

As mentioned above when describing action 301, sensing the touch pattern may be based on the resistance measurement between two or more outer touch sensitive areas 201, 202 out of the plurality of outer touch sensitive areas 201-208.

For example, at certain intervals the activating circuit 242 may evaluate if there is a short circuit between two outer touch sensitive areas 201, 202. Thus, a measurement is performed to check if there is a connection between two or three outer touch sensitive areas 201, 202 through the conductivity of the touching object, such as the skin of the user.

However, there are many situations where the fingers are close to each other without the intention to control another device. This may happen when the hand is in a resting state, a closed fist, or when gripping something. Then the electronic ring-shaped device 120 may register a false positive. That is, the electronic ring-shaped device 120 may trigger the gesture sensing when the user did not intend to do so. The following embodiments will present different solutions to this problem. Generally, the above described trigger to start sensing gestures based on the sensed touch pattern may be combined with other triggers to provide a more robust start trigger.

In one embodiment, a start trigger is detected by the electronic ring-shaped device 120 as described above. The start trigger may be combined with a gesture of the arm, e.g. a rapid tilt back-and-forth. Such a distinct gesture may be detected by either the above-mentioned motion sensor, such as an IMU or accelerometer, of the wearable electronic device 110 or the electronic ring-shaped device 120.

In one embodiment, the start trigger is only enabled when the display 115 of the wearable electronic device 110 is activated. The display 115 may be triggered by an arm movement making the display 115 viewable to the user. The reception of a message or any other system notification, or a call may also enable the start trigger.

In one embodiment, a system comprising the electronic ring-shaped device 120 and the wearable electronic device 110 has learned typical other hand positions or gestures than the ones that should trigger the gesture sensing from how they activate the touch sensitive areas 201-208, 222 on the electronic ring-shaped device 120. For example, a closed fist would likely activate a different set of touch sensitive areas 201-208, 222 than only the ones used for starting one-handed operation, both on the outside but also by the pressure of different touch sensitive areas on the inside of the electronic ring-shaped device 120. By learning such gestures or hand positions that are not meant to trigger the gesture sensing, those gestures may be filtered out from the starting trigger of the one-handed operation. In one embodiment, the trigger of the gesture sensing, which may be part of a ring UI mode, is notified in the wearable electronic device 110, e.g. by two quick vibrations. This makes the user aware that the gesture sensing has triggered, either as an intentional activation or involuntary. In the latter case, this allows the user to rapidly turn off the ring UI mode and use the sensor input data for the learning process.

In one embodiment, when the wearable electronic device 110 has notified the user the user, such as with two quick vibrations, the user may need to do an additional gesture to confirm the ring UI mode. The additional gesture may be sensed by the wearable electronic device 110. This additional gesture may be a rapid tilt of the arm or hand back-and-forth, which may be followed by another notification from the wearable electronic device 110 as confirmation, such as one quick vibration. The absence of such a confirmation gesture within a certain amount of time, such as 1 second, implies that the ring UI mode is not activated. Then, at involuntary activation of the trigger event, the user simply avoids the confirmation gesture. Thus, if the electronic ring-shaped device 120 does not receive a confirmation from the wearable electronic device 110 the electronic ring-shaped device 120 does not trigger gesture sensing although the electronic ring-shaped device 120 sensed the triggering touch pattern.

The wearable electronic device 110 and/or the electronic ring-shaped device 120 may turn off the ring UI mode based on sensing a similar gesture as the one that turns on the mode. However, the gesture that turns off the ring UI mode may also differ from the gesture that turns on the mode.

It should be noted that above examples of confirmation gestures or notifications are only examples, and other methods may be used.

### Action 414

Once enough touch sensitive areas are covered the activating circuit 242 triggers gesture sensing and the touch circuit 244 powers up in normal mode.

In some embodiments herein the touch circuit 244 sense all the touch sensitive areas at the same side as the activating circuit 242 was triggered to determine if any gesture is performed. For example, if the third finger 273 triggers the activation of the touch circuit 244 by touching the second outer touch sensitive area 202 arranged on the palm side of the electronic ring-shaped device 120, then the touch circuit 244 may be configured to sense gestures with the outer touch sensitive areas on the palm side, such as any one or more of the first to the fifth outer touch sensitive areas 201-205.

### Action 415

The electronic ring-shaped device 120 may check if a gesture is performed. If no gesture is detected within a certain amount of time (for example in the range of a fraction of a second) the touch circuit 244 may revert to low power mode and the activating circuit 242 may be operational again to sense the touch pattern in order to trigger activation of the touch circuit 244.

### Action 416

Once a gesture is performed and registered the electronic ring-shaped device 120 may determine what gesture it was and send a corresponding bit stream over the interface to the paired electronic device, such as the wearable electronic device 110. The touch circuit 244 may determine what gesture it was and send the corresponding bit stream.

### Action 417

In some embodiments herein the touch circuit 244 is reset and is ready to sense a new gesture.

If no gesture is detected within a certain amount of time (for example in the range of milliseconds) the touch circuit 244 may revert to low power mode and the activating circuit 242 may be operational again to sense a new touch pattern in order to trigger activation of the touch circuit 244.

The above sections described a basic operation of the electronic ring-shaped device 120 and its design and calibration together with a brief description of some interaction with the wearable electronic device 110. The below embodiments will focus on how the electronic ring-shaped device 120 collaborates with the wearable electronic device 110 to navigate a UI of an electronic device, such as the GUI of the wearable electronic device 110 and/or the UI of the third electronic device 130. An example of this is illustrated in a flowchart of FIG. 4e and will be described now.

The process starts at some state of the UI, such as the GUI of the wearable electronic device 110. In this example a user has activated a menu e.g., by tapping on the electronic ring-shaped device 120. The tapping on the electronic ring-shaped device 120 may replace a touch on the display 115 of the wearable electronic device 110 or a button on the wearable electronic device 110. In some other embodiments the tapping on the electronic ring-shaped device 120 replaces a touch on the display 135 of the third electronic device 130 or a button on the third electronic device 130.

### Action 421

While the display 115, 135 presents a navigation menu of the UI, the electronic ring-shaped device 120 may detect a swipe gesture by its outer touch sensors 201-208. Information identifying the swipe gesture is communicated to the wearable electronic device 110. Thus, the wearable electronic device 110 obtains the information identifying the swipe gesture.

### Action 422

The swipe gesture may be used by the UI in several ways. For example, a cursor may be shown on the display 115 of the wearable electronic device 110 and/or the display 135 of the third electronic device 130, and a hand movement then moves that cursor on the display 115, 135.

In some other embodiments the complete content on the display 115, 135 is moved around. An icon in the middle of the display 115, 135 may be a selected icon. The selection may be visualised to the user by highlighting the selected icon. In that way, the user may navigate on the display 115, 135 and make selections. How the gesture is used by the UI may be dependent on a context in which the method is used. For example, which of the above two alternatives that is used may depend on the context in which the method is used.

### Action 423

The wearable electronic device 110 detects a movement based on the motion sensor data from the motion sensor 114 of the wearable electronic device 110.

### Action 424

As the user moves the hand slightly, the content of the display 115, 135 is adjusted accordingly based on the motion sensor data from the motion sensor 114. For example, the content of the display 115, 135 may be shifted in the same direction as the hand. By moving the hand slightly, the user may adjust the display content until a target icon is in the middle or at the cursor. The speed of the hand movement may control the speed of the scroll of the display content.

### Action 425

Thereafter, the electronic ring-shaped device 120 checks if it senses a further touch or gesture.

### Action 426

The electronic ring-shaped device 120 may check if it senses a short touch or a longer touch.

### Action 427

A short tap or a quick press on one of the touch sensors 201-208, 222, such as the second outer touch sensitive area 202, may be detected to select and/or activate the function of the target icon.

### Action 428

When a target function has been activated the state of the wearable electronic device 110 and/or the third electronic device 130 may be reverted back to a previous state e.g., where it was before the ring UI mode was triggered.

### Action 429

If instead the electronic ring-shaped device 120 senses a long touch, the process of controlling the UI based on the touch sensor data and the motion sensor data may be cancelled. For example, moving the content of the display 115, 135 may be cancelled or stopped.

### Action 430

The state of the wearable electronic device 110 and/or the third electronic device 130 may be reverted back to a previous state e.g., where it was before the ring UI mode was triggered if the process of controlling the UI based on the touch sensor data and the motion sensor data is cancelled.

In another context, the user has selected a song list with the UI. Then, the user may initiate the scrolling through the songs by a swipe movement up/down on the electronic ring-shaped device 120 and then continue moving the hand slightly to continue the scrolling until the target song appears. The speed of the hand movement, which is detected by the motion sensor 114, may control the scrolling speed. Then the user may select the song by a tap on the electronic ring-shaped device 120. If the user instead swipes the finger, such as the third finger 273, on the electronic ring-shaped device 120 to the right or left, the song list changes, and the user now scrolls through different song lists until the user taps on the electronic ring-shaped device 120. After this the user may either start from the beginning of that song list with another tap or start scrolling through the songs by a swipe down/up on the electronic ring-shaped device 120.

In some different embodiments, the movement of items or content on the display 115, 135 does not follow the direct movement of the hand. Instead, by moving the hand slightly in one direction, e.g., to the left, the scrolling starts in that direction and continues until the user moves the hand to a specific position, such as back to its starting position. A movement in another direction initiates the movement on the display 115, 135 accordingly until the hand moves to the specific position, such as back to its starting position. The specific position may be pre-determined. The speed of the hand movement may control the scrolling speed. In an example there is a starting point of the arm where the content of the display 115, 135 is still. If the arm moves slightly to the left, the scrolling continues as long as the arm is in that position, and to stop the scrolling the arm returns to the starting position which is detected by the motion sensor 114 of the wearable electronic device 110. If the arm moves little from the starting position, the screen moves slow, but if the arm moves further from the starting position the content of the display 115, 135 moves fast based on the sensor signal from the motion sensor 114.

It is also possible to control the third electronic device 130 without the display 135 similarly to what is described directly above. For example, a selection of a parameter value from a range of parameter values, such as a parameter value determining the light intensity of the light system, may also be based on continuing to change the parameter value while the wearable electronic device 110 does not detect that the wearable electronic device 110 is positioned at the specific position, such as the starting position.

In yet some different embodiments, the wearable electronic device 110 need not be moved (e.g., to the left/right) to navigate, but instead detects a leaning or tilting motion of the hand slightly in one or the other direction to start the movement until the user stops tilting the hand and the movement stops. The speed of the tilt movement may control the scrolling speed.

In some embodiments detecting a long press instead of a tap means that the target item, such as an icon, song, or list element is selected and will be moved according to the movement of the hand detected by the motion sensor 114.

It should be clear that there are many additional gestures and input combinations possible based on the touch sensors 201-208, 222 above, that may be supported by the combined movement of the wearable electronic device 110. This includes a touching of the electronic ring-shaped device 120 simultaneously with detecting a movement of the hand with the motion sensor 114, for example by detecting double-tapping on the electronic ring-shaped device 120 while detecting a distinct pointing of the hand in a certain direction.

Embodiments herein take advantage of combined movements of the wearable electronic device 110 via hand movements, captured by the motion sensor 114 of the wearable electronic device 110, as well as gestures on the electronic ring-shaped device 120 captured by the touch sensors 201-208, 222, such as capacitive touch sensors.

Embodiments herein use capacitive touch of the electronic ring-shaped device 120 to detect the touching and pressure of fingers located on an outer face of the electronic ring-shaped device 120. When for example a swipe movement is detected, the electronic ring-shaped device 120 communicates this to the wearable electronic device 110. Then the motion sensor 114, such as an IMU, of the wearable electronic device 110 may take over the swipe movement by movements of the arm carrying the wearable electronic device 110. Swiping in this context may also mean navigating the UI by moving the visible area or cursor on the display 115, 135. Selection or activation of a function may be handled by a subsequent touch gesture, e.g., tap or multitap, on the electronic ring-shaped device 120 which also may be detected by the capacitive touch sensors 201-208, 222.

Capacitive touch techniques are of fairly low complexity enabling a small size overhead, yet enabling a usage which has a sufficient number of distinguishable gestures for a rich UI.

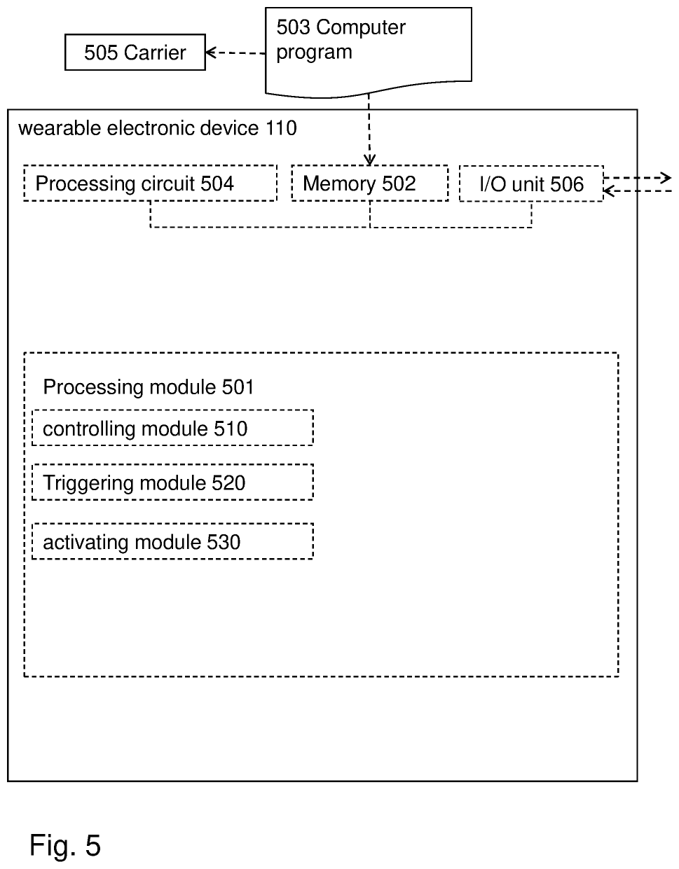

FIG. 5 illustrates a schematic block diagram of embodiments of the wearable electronic device 110.

The wearable electronic device 110 may comprise a processing module 501 for performing the above method actions. The processing module 501 may comprise a controlling module 510 to, e.g., control the UI of the wearable electronic device 110. The processing module 501 may comprise a triggering module 520 to, e.g., trigger control of the UI. The processing module 501 may comprise an activating module 530 to, e.g., activate a function presented with the UI.

To perform the actions 300-305 above, the wearable electronic device 110 is configured to control the UI of the wearable electronic device 110 and/or the further electronic device 130 other than the wearable electronic device 110 and the electronic ring-shaped device 120, i.e., the third electronic device 130. As mentioned above, the wearable electronic device 110 comprises the motion sensor 114 and is further configured to, e.g., by means of the IF CU 246, communicate with the electronic ring-shaped device 120 comprising the one or more touch sensors 201-208.

The wearable electronic device 110 is further configured to, e.g., by means of the controlling module 510, control the UI based on the touch sensor data communicated from the electronic ring-shaped device 120 and further based on the motion sensor data from the motion sensor 114.

In some embodiments the wearable electronic device 110 is further configured to, e.g., by means of the controlling module 510, control the UI by moving the cursor on the display 115, 135 of the UI and/or moving the content of the display 115, 135.

In some embodiments the wearable electronic device 110 is further configured to, e.g., by means of the controlling module 510, control the UI by scrolling through items of the display 115, 135. Then the touch sensor data may initiate the scrolling which is continued based on the motion sensor data.

The wearable electronic device 110 may further be configured to, e.g. by means of the triggering module 520, trigger controlling the UI based on the touch sensor data and further based on the motion sensor data. The triggering is based on the first touch sensor data communicated from the electronic ring-shaped device 120 and controlling is based on the second touch sensor data communicated from the electronic ring-shaped device 120.

The wearable electronic device 110 may further be configured to, e.g. by means of the activating module 530, activate the function of the UI based on further touch sensor data from the electronic ring-shaped device 120. For example, the wearable electronic device 110 may be configured to activate the function of the GUI of the wearable electronic device 110. In some other embodiments, the wearable electronic device 110 is configured to activate the function of the UI of the third electronic device 130.

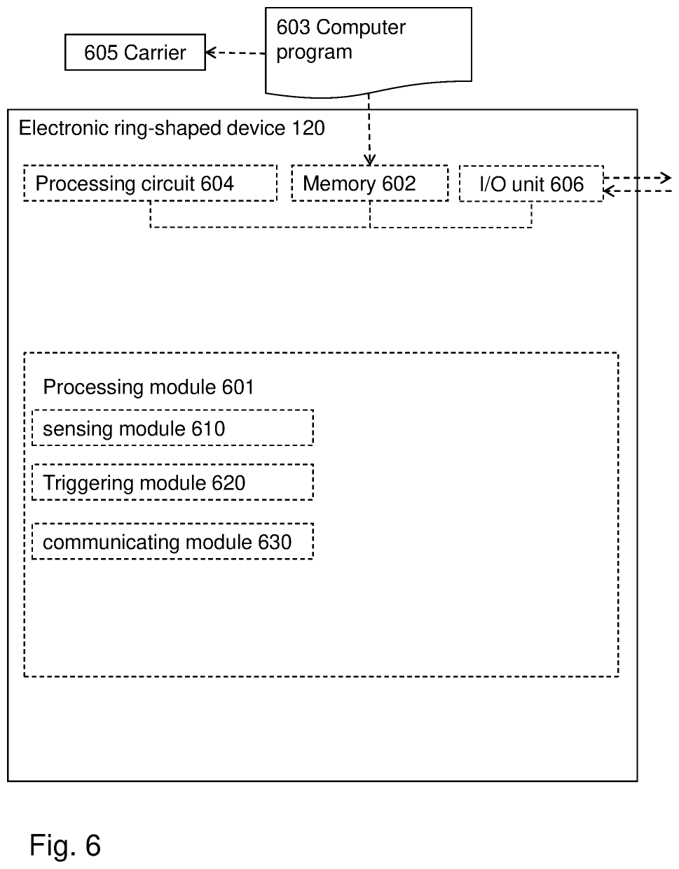

FIG. 6 illustrates a schematic block diagram of embodiments of the electronic ring-shaped device 120.

The electronic ring-shaped device 120 may comprise a processing module 601 for performing the above method actions. The processing module 601 may comprise a sensing module 610 to, e.g. sense touch with the touch sensors 201-208, 222. The processing module 601 may further comprise a triggering module 620 to, e.g. trigger activation of gesture sensing with the touch sensors 201-208 and/or to trigger control of the UI based on input from the electronic ring-shaped device 120. The processing module 601 may further comprise a communicating module 630 to, e.g. communicate sensor data and other relevant information with the wearable electronic device 110.

To perform the actions 300-305 above, the electronic ring-shaped device 120 is configured to communicate the touch sensor data from the one or more touch sensors 201-208 to the wearable electronic device 110.

The electronic ring-shaped device 120 may further be configured to, e.g. by means of the sensing module 610, sense touch with the touch sensors 201-208, 222.

In some embodiments the electronic ring-shaped device 120 is further configured to, e.g. by means of the triggering module 620, trigger activation of gesture sensing with the outer touch sensors 201-208 and/or to trigger control of the UI at least partly based on input from the electronic ring-shaped device 120. The triggering may be based on the first touch sensor data.

The embodiments herein may be implemented through a processing circuit 504, 604 e.g. comprising one or more processors, in the respective wearable electronic device 110 and electronic ring-shaped device 120 depicted in FIGS. 5 and 6, together with computer program code, e.g. computer program, for performing the functions and actions of the embodiments herein. The program code mentioned above may also be provided as a computer program product, for instance in the form of a data carrier carrying computer program code for performing the embodiments herein when being loaded into the wearable electronic device 110 or the electronic ring-shaped device 120. One such carrier may be in the form of a CD ROM disc. It is however feasible with other data carriers such as a memory stick. The computer program code may furthermore be provided as pure program code on a server and downloaded to the wearable electronic device 110 or the electronic ring-shaped device 120.

The wearable electronic device 110 and the electronic ring-shaped device 120 may further comprise a respective memory 502, 602 comprising one or more memory units. The memory 502, 602 comprises instructions executable by the processing circuit in the wearable electronic device 110 and the electronic ring-shaped device 120. The memory 502, 602 is arranged to be used to store e.g. information, indications, data, configurations, and applications to perform the methods herein when being executed in the wearable electronic device 110 or the electronic ring-shaped device 120. The memory 502 may be a non-volatile memory e.g., comprising NAND gates, from which the wearable electronic device 110 or the electronic ring-shaped device 120 may load its program and relevant data. Updates of the software may be transferred via a wireless connection.

In some embodiments, a computer program 503, 603 comprises instructions, which when executed by a processor, such as the processing circuit 504, 604 of the wearable electronic device 110 and/or the electronic ring-shaped device 120, cause the processor to perform any of the method actions above.

In some embodiments, a carrier 505, 605 comprises the respective computer program 503, 603 wherein the carrier 505, 605 is one of an electronic signal, an optical signal, an electromagnetic signal, a magnetic signal, an electric signal, a radio signal, a microwave signal and a computer-readable storage medium.

To perform the method actions above, the wearable electronic device 110 and the electronic ring-shaped device 120 may each comprise an Input and Output (I/O) unit 506, 606. The I/O unit 506, 606 may comprise the IF CU 246, 256 or be configured to communicate with the other wearable electronic device e.g., the electronic ring-shaped device 120 or the wearable electronic device 110. The I/O unit 506, 606 may further be part of one or more user interfaces, such as the UI of the wearable electronic device 110, and may further comprise a motion sensor, such as the motion sensor 114 of the wearable electronic device 110.

As mentioned above embodiments herein may be carried out by the electronic device system 100 which may comprise the wearable electronic device 110 and the electronic ring-shaped device 120. The electronic device system 100 is configured to:
communicate, by the electronic ring-shaped device 120, the touch sensor data from the one or more touch sensors 201-208 to the wearable electronic device 110; and
control the UI, by the wearable electronic device 110, based on the touch sensor data and further based on the motion sensor data from the motion sensor 114.

Those skilled in the art will appreciate that the modules and/or units in the wearable electronic device 110 and the electronic ring-shaped device 120 described above may refer to a combination of analog and digital circuits, and/or one or more processors configured with software and/or firmware, e.g., stored in the wearable electronic device 110 or the electronic ring-shaped device 120, that when executed by, e.g., the processing circuit 501, 601, above causes the wearable electronic device 110 and/or the electronic ring-shaped device 120 to perform the method actions above. The processing circuit 501, 601, as well as the other digital hardware, may be included in a single Application-Specific Integrated Circuitry (ASIC), or several processors and various digital hardware may be distributed among several separate components, whether individually packaged or assembled into a system-on-a-chip (SoC).

As used herein, the term “module” may refer to one or more functional modules, each of which may be implemented as one or more hardware modules and/or one or more software modules and/or a combined software/hardware module. In some examples, the module may represent a functional unit realized as software and/or hardware.

As used herein, the term “computer program carrier”, “program carrier”, or “carrier”, may refer to one of an electronic signal, an optical signal, a radio signal, and a computer readable medium. In some examples, the computer program carrier may exclude transitory, propagating signals, such as the electronic, optical and/or radio signal. Thus, in these examples, the computer program carrier may be a non-transitory carrier, such as a non-transitory computer readable medium.

As used herein, the term “processing module” may include one or more hardware modules, one or more software modules or a combination thereof. Any such module, be it a hardware, software or a combined hardware-software module, may be a controlling means, triggering means, activating means, communicating means or the like as disclosed herein. As an example, the expression “means” may be a module corresponding to the modules listed above in conjunction with the figures.

As used herein, the term “software module” may refer to a software application, a Dynamic Link Library (DLL), a software component, a software object, an object according to Component Object Model (COM), a software component, a software function, a software engine, an executable binary software file or the like.

The terms “processing module” or “processing circuit” may herein encompass a processing unit, comprising e.g. one or more processors, an Application Specific integrated Circuit (ASIC), a Field-Programmable Gate Array (FPGA) or the like. The processing circuit or the like may comprise one or more processor kernels.

As used herein, the expression “configured to/for” may mean that a processing circuit is configured to, such as adapted to or operative to, by means of software configuration and/or hardware configuration, perform one or more of the actions described herein.

As used herein, the term “action” may refer to an action, a step, an operation, a response, a reaction, an activity or the like. It shall be noted that an action herein may be split into two or more sub-actions as applicable. Moreover, also as applicable, it shall be noted that two or more of the actions described herein may be merged into a single action.

As used herein, the term “memory” may refer to a hard disk, a magnetic storage medium, a portable computer diskette or disc, flash memory, Random Access Memory (RAM) or the like. Furthermore, the term “memory” may refer to an internal register memory of a processor or the like.

As used herein, the term “computer readable medium” may be a Universal Serial Bus (USB) memory, a DVD-disc, a Blu-ray disc, a software module that is received as a stream of data, a Flash memory, a hard drive, a memory card, such as a MemoryStick, a Multimedia Card (MMC), Secure Digital (SD) card, etc. One or more of the aforementioned examples of computer readable medium may be provided as one or more computer program products.

As used herein, the term “computer readable code units” may be text of a computer program, parts of or an entire binary file representing a computer program in a compiled format or anything there between.

As used herein, the terms “number” and/or “value” may be any kind of number, such as binary, real, imaginary or rational number or the like. Moreover, “number” and/or “value” may be one or more characters, such as a letter or a string of letters. “Number” and/or “value” may also be represented by a string of bits, i.e. zeros and/or ones.

As used herein, the expression “in some embodiments” has been used to indicate that the features of the embodiment described may be combined with any other embodiment disclosed herein.

Even though embodiments of the various aspects have been described, many different alterations, modifications and the like thereof will become apparent for those skilled in the art. The described embodiments are therefore not intended to limit the scope of the present disclosure.

1-20. (canceled)

21. A method, performed by a wearable electronic device, for controlling a user interface (UI), wherein the wearable electronic device is configured to communicate with an electronic ring-shaped device comprising one or more touch sensors, the method comprising:
controlling the UI based on touch sensor data communicated from the electronic ring-shaped device and further based on motion sensor data from a motion sensor of the wearable electronic device.

22. The method of claim 21, further comprising:
triggering controlling the UI based on the touch sensor data and further based on the motion sensor data, wherein the triggering is based on a first touch sensor data communicated from the electronic ring-shaped device and controlling is based on a second touch sensor data communicated from the electronic ring-shaped device.

23. The method of claim 21, further comprising:
activating a function of the UI based on further touch sensor data from the electronic ring-shaped device.

24. The method of claim 21, wherein the touch sensor data comprises gesture data.

25. The method of claim 21, wherein controlling the UI comprises moving a cursor on a display of the UI and/or moving a content of the display.

26. The method of claim 21, wherein controlling the UI comprises scrolling through items of the display and wherein the touch sensor data initiates the scrolling which is continued based on the motion sensor data.

27. The method of claim 21, wherein the motion sensor of the wearable electronic device is any of an Inertial Measurement Unit (IMU) and a magnetic sensor.

28. The method of claim 21, wherein the UI is a graphical UI (GUI) of the wearable electronic device.

29. The method of claim 21, wherein the UI is a UI of a further electronic device other than the wearable electronic device and the electronic ring-shaped device.

30. The method of claim 29, wherein the further electronic device is any of an Internet-of-Things device, a television, a computer, a mobile phone, an audio player, a headset, a light system, a thermostat and a drone.

31. A wearable electronic device configured to control a graphical user interface (UI), wherein the wearable electronic device comprises a motion sensor and is further configured to:
communicate with an electronic ring-shaped device comprising one or more touch sensors; and
control the UI based on touch sensor data communicated from the electronic ring-shaped device and further based on motion sensor data from the motion sensor.

32. The wearable electronic device of claim 31, being further configured to trigger controlling the UI based on the touch sensor data and further based on the motion sensor data, wherein the triggering is based on a first touch sensor data communicated from the electronic ring-shaped device and controlling is based on a second touch sensor data communicated from the electronic ring-shaped device.

33. The wearable electronic device of claim 31, comprising any of a watch, a smart band, a mobile phone, a headset, electronic clothing and electronic eyewear.

34. The wearable electronic device of claim 31, wherein the wearable electronic device is configured to be worn on a wrist of an arm.

35. A method performed by an electronic device system comprising a wearable electronic device and an electronic ring-shaped device wherein the wearable electronic device comprises a motion sensor, and wherein the electronic ring-shaped device comprises one or more touch sensors, the method comprising:
communicating, by the electronic ring-shaped device, touch sensor data from the one or more touch sensors to the wearable electronic device; and
controlling a user interface (UI), by the wearable electronic device, based on the touch sensor data and further based on motion sensor data from the motion sensor.

36. An electronic device system comprising a wearable electronic device and an electronic ring-shaped device, wherein the wearable electronic device comprises a motion sensor, and wherein the electronic ring-shaped device comprises one or more touch sensors, wherein the electronic device system is configured to:
communicate, by the electronic ring-shaped device, touch sensor data from the one or more touch sensors to the wearable electronic device; and
control a user interface (UI) by the wearable electronic device, based on the touch sensor data and further based on motion sensor data from the motion sensor.

37. The electronic device system of claim 36, wherein the one or more touch sensors comprise one or more capacitive touch sensors.

38. The electronic device system of claim 36, wherein the one or more touch sensors are arranged on an outer face of the electronic ring-shaped device.

39. A non-transitory computer-readable medium comprising, stored thereupon, a computer program comprising computer readable code units configured so that when executed on a processor the computer readable code units cause the processor to perform the method of claim 21.
